(19) United States
(12) Patent Application Publication
(10) Pub. No.: US 2018/0134994 A1
(43) Pub. Date: May 17, 2018

(54) APPARATUS AND METHOD FOR THE TREATMENT OF A SUBSTRATE WITH OZONE BUBBLES

(71) Applicant: Xeros Limited, Rotherham (GB)

(72) Inventors: John Edward STEELE, Rotherham, Yorkshire (GB); William Bauer Jay ZIMMERMAN, Sheffield, Yorkshire (GB)

(73) Assignees: Xeros Limited, Rotherham (GB); Xeros Limited, Rotherham (GB)

(21) Appl. No.: 15/737,407

(22) PCT Filed: Jun. 17, 2016
(86) PCT No.: PCT/GB2016/051811

§ 371 Date: Dec. 18, 2017

(30) Foreign Application Priority Data
Jun. 18, 2015 (GB) 1510746.9

(51) Int. Cl. C11D 3/386; D06F 35/00; A47L 15/00; B08B 7/00; D06L 4/50; D06L 4/75; C11D 3/395; D21C 5/02; D21C 9/153; C11D 3/48; C11D 11/00; C01B 13/11

(52) U.S. Cl. CPC C11D 3/38663; C01B 2201/64; A47L 15/0015; B08B 7/0035; A47L 15/0047; D06F 35/002; D06L 4/50; D06L 4/75; C11D 3/3953; C11D 3/386; D21C 5/027; D21C 9/153; C11D 3/48; C11D 11/0017; C01B 13/115; D06F 35/001

(57) ABSTRACT

Apparatus (200) for the treatment of one or more substrates comprising a treatment chamber configured to receive a liquid medium and one or more substrates; a supply of a treatment gas comprising ozone; and one or more conduits to convey said treatment gas to a bubble generator (41) wherein said bubble generator is operable to form bubbles of said treatment gas in said liquid medium, wherein the apparatus comprises a multiplicity of solid particles (46). A method of treating one or more substrates, the method comprising agitating said one or more substrates in a treatment formulation comprising a multiplicity of solid particles, a liquid medium and bubbles of ozone.

### FIELD OF THE INVENTION

The present invention relates to an apparatus for the treatment of one or more substrates which utilizes ozone, particularly bubbles of ozone of a specific size range. Furthermore, the invention discloses methods of treating one or more substrates utilizing bubbles of ozone. The treatment apparatus and method of the invention further incorporates a multiplicity of solid particles for use therein.

### BACKGROUND TO THE INVENTION

Ozone is useful for a variety of applications, particularly in the sterilisation of drinking water and laundry (e.g. in hospitals). Being a powerful oxidising agent, it is also effective in oxidising and/or breaking chemical bonds, such as those present in bleachable fabric stains thereby improving cleaning performance.

Ozone can be utilized to treat a variety of substrates and confer wide ranging effects such as those associated with cleaning, bleaching and chemical modification (including oxidation) of the substrates.

Conventionally, ozone is produced by a plasma reactor. Plasmas are gases to which an electric field is applied, dissociating molecules of the gas into charged ions. In the case of ozone, a flux of air or oxygen is subjected to a high voltage discharge that dissociates the oxygen to produce ozone. The ions can be employed for a number of purposes although it is known to be a property of plasmas that ions are extinguished once they collide with surfaces, for example the surfaces of the container in which the plasma is formed, or the plates of the electrodes. Consequently, containers tend to be large, and electrode plates separated by as large a distance as possible, so that the energy put in to create ions is not lost by ion extinction.

Such large distances have the corollary effect that electric voltages applied by the plates have to be substantial in order to create a sufficiently concentrated electric field to form the desired plasma. Indeed, the high voltage required is frequently the reason why plasmas are not employed in many situations. For example, ozone is produced in plasma, but the cost of production using this technique renders it uneconomic for many purposes, such as its use in laundry applications, including domestic and industrial washing machines and in industrial or domestic dishwashers.

There have been very few attempts to date that have successfully addressed the problem of providing a small, less energy-intensive plasma reactor for producing ozone. International patent application WO2010/079351 provides a plasmolysis device for the production of ozone comprising, inter alia, electrodes, with a space between them of less than 1 mm, a conduit to supply ozone to an outlet and which can form part of a sterilization unit for water treatment. The apparatus of WO2010/079351 is not however specifically adapted to treat one or more substrates contained therein and does not disclose laundry or dishwashing as a possible field of application.

Furthermore, and as alluded to above, the means and form by which ozone is delivered to the substrate influences the efficiency and the efficacy of the treatment conducted. It is known for example that forming small bubbles in applications such as sewage treatment, whereby it is desirable to maximize the amount of dissolved oxygen in the water being treated, can facilitate an increased supply of oxygen to respiring bacteria involved in sewage digestion and improve the efficiency of the process.

A particular example of a means of providing an effective and more efficient method for producing small bubbles is disclosed in international patent application WO2008/053174. This document discloses a bubble generator for producing small bubbles of gas in a liquid comprising a fluidic oscillator and a conduit opening into a liquid wherein the gas passing along the conduit is oscillated without oscillating the conduit, other than by any reaction of the reacting gas. Efficiency is said to be maximised by the use of such a device as the entire energy of the system is in oscillating the gas, and not the conduit through which it is passed. WO2010/079351 does not however disclose the use of such a device for treating substrates, nor does it suggest laundry or dishwashers as a possible field of application.

It is an object of the present disclosure to produce and/or deliver ozone to treat a substrate via a liquid medium in a more efficacious and efficient manner. Furthermore, it is an object of the present disclosure to provide a washing machine modified to produce and/or deliver ozone to treat soiled substrates contained therein.

Thus, the present disclosure seeks to provide a treatment apparatus and/or method that can ameliorate or overcome the above-noted problems associated with the prior art. Furthermore, the present disclosure seeks to provide one or more of the following:
i. A more efficient apparatus for the use of ozone bubbles in a treatment process;
ii. An improved method of cleaning soiled substrates;
iii. A washing machine that can effectively utilize ozone in a cleaning operation but with reduced water consumption;
iv. An improved means of using ozone in a paper recycling and/or de-inking process.
v. An improved means of using and preparing a multiplicity of solid particles in the treatment of substrates;
vi. An improved means for inhibiting the build-up of bacteria in a washing machine;
vii. An improved dishwasher that can effectively utilize ozone in a cleaning operation but with reduced water consumption;
viii. An improved apparatus and method for reducing stains a substrate which is or comprises a textile material;
ix. An improved apparatus and method for reducing stains on hard substrates including for example: glass, metal, alloy, ceramic, plastic and wood.

### SUMMARY OF THE INVENTION

In a first aspect, the present invention provides an apparatus for the treatment of one or more substrates comprising:

a treatment chamber configured to receive a liquid medium and one or more substrates;
a supply of a treatment gas comprising ozone; and
one or more conduits to convey said treatment gas to a bubble generator wherein said bubble generator is operable to form bubbles of said treatment gas in said liquid medium, preferably wherein said bubbles have an average diameter of no more than 10 mm, wherein the apparatus comprises a multiplicity of solid particles.

Advantageously, a treatment apparatus adapted to produce bubbles of ozone in the liquid medium as described herein enhances the efficacy of the treatment of the substrates contained therein.

In said first aspect, the apparatus can further comprise:

a gas source to provide a feed gas comprising oxygen;
a plasma generator comprising electrodes, having a space between them which is preferably no more than 10 mm;
one or more delivery conduits to transport said feed gas from the gas source through the space between the electrodes;
a power source to apply a voltage across the electrodes to dissociate the oxygen to form said treatment gas comprising ozone.

Advantageously, the apparatus thus comprises a plasma generator to provide the treatment gas comprising ozone. The inclusion of such a plasma generator to dissociate oxygen and form the treatment gas facilitates an effective means of “dosing” the bubbles emanating from the bubble generator with ozone.

In a second aspect, the present invention provides an apparatus for the treatment of one or more substrates comprising:

a treatment chamber configured to receive a liquid medium and one or more substrates;
a gas source to provide a feed gas comprising oxygen;
a plasma generator comprising electrodes, having a space between them which is preferably no more than 10 mm;
one or more delivery conduits to transport said feed gas from the gas source through the space between the electrodes;
a power source to apply a voltage across the electrodes to dissociate the oxygen to form a treatment gas comprising ozone; and
one or more conduits to convey said treatment gas to a bubble generator wherein said bubble generator is operable to form bubbles of said treatment gas in said liquid medium, preferably wherein said bubbles have an average diameter of no more than 10 mm, wherein the apparatus comprises a multiplicity of solid particles.

In the apparatus and methods disclosed herein, the electrodes preferably have a space between them of no more than 10 mm, more preferably no more than 5 mm, even more preferably no more than 2 mm and especially no more than 1 mm. Preferably, the electrodes have a space between them of at least 0.001 mm, more preferably at least 0.003 mm, more preferably at least 0.005 mm, more preferably at least 0.01 mm and even more preferably at least 0.1 mm. Preferably, the electrodes have a space between them of from 0.01 to 1 mm.

The spacing of the electrodes is suitably measured as the minimum distance from the surface of one electrode to the opposite electrode. Where the electrode is coated, the spacing is suitably measured as the minimum distance from the coated surface of one electrode to the coated surface of the opposite electrode.

The electrodes are preferably substantially parallel to one another.

The electrodes are preferably coated with a dielectric material. Suitable dielectric materials include polymers (such as polyethylene and polypropylene), or more preferably inorganic oxides such as silica (quartz), aluminium oxide and the like. The dielectric coating preferably has a thickness of from 1 to 500 microns, more preferably from 1 to 300 microns and especially from 10 to 200 microns.

Advantageously, a treatment apparatus comprising a plasma generator to form ozone and a bubble generator operable to produce bubbles of ozone, as described herein, enhances the efficacy of the treatment of the substrates contained therein. Furthermore, said electrode spacing advantageously facilitates miniaturization of the apparatus and reduces its overall power consumption.

In the present invention, the apparatus preferably further comprises a fluidic oscillator operable to oscillate the flow of at least said treatment gas.

Preferably, the oscillations effected by the fluidic oscillator are at a frequency from about 0.01 to about 1000 Hz, more preferably from about 0.1 to about 500 Hz, even more preferably from about 1 to about 100 Hz, especially from about 5 to about 50 Hz and most especially from about 10 to about 30 Hz.

In the present invention, said bubble generator suitably comprises at least one outlet that opens into said liquid medium.

In the present invention, the treatment gas is oscillated along said one or more conduits without oscillating the conduits. Thus, there is no oscillation of the conduits other than by any reaction of said conduits to the oscillation of the treatment gas.

Preferably, only the treatment gas is oscillated. Preferably, the fluidic oscillator has no mechanical moving parts.

In the present invention, the fluidic oscillator is arranged to oscillate the treatment gas and said oscillation is of the type that exhibits no more than 30% backflow of gas from an emerging bubble, preferably from about 10 to about 30%, preferably from about 10% to about 20%. This is preferably provided by an arrangement in which a fluidic oscillator divides flow between two paths, at least one of said paths forming said source. In this case, flow is primarily only in the forwards direction with flow ceasing periodically in a square wave form with the base of the square wave being essentially no-flow.

Backflow here means that, of a net gas flow rate from said conduit conveying said treatment gas of x m³ s⁻¹, (x+y) m³ s⁻¹ is in the positive direction while (−y) m³ s⁻¹ is in the negative direction, 100(y/(y+x)) being defined as the percentage backflow. Some backflow is largely inevitable, particularly with the arrangement where flow splits between paths, since there will always be some rebound. Indeed, such is also a tendency with bubble generation since, with the removal of pressure, back pressure inside the bubble will tend to cause some backflow. Indeed, backflow refers to the conduit carrying the treatment gas to the bubble generator (i.e. at the conduit or outlet opening into the liquid medium), because backflow may vary by virtue of the compressibility of the gas.

The fluidic oscillator can comprise an arrangement in which gas flow is oscillated between two paths, at least one of said paths providing a source for said treatment gas. Preferably, the fluidic oscillator comprises a fluidic diverter supplied with said treatment gas under constant pressure through a supply port that divides into respective output ports, and including means to oscillate flow from one output port to the other. Preferably, said means comprises each output port being controlled by respective control ports. Preferably, the control ports are interconnected by a closed control loop. Alternatively, a branch of each output port may supply each respective control port, whereby part of the flow in an output port becomes a control flow, switching the supply flow from that output port to the other output port.

When a control loop is employed, the control ports are arranged so that each has reduced pressure when the gas flows through its respective output, and increased pressure when there is no flow through its respective output. Consequently, when gas flows out of a control port, it detaches the main supply flow of the gas from the wall in which said control port is formed and switches that flow from the output port associated with that wall to the other output port, attaching the main flow from supply port to the wall associated with the other control port, and so the situation reverses with the main flow from the supply port oscillating between said output ports with a frequency determined by a number of factors including the length of the control loop.

Preferably, there are at least two of said conduits to convey said treatment gas to said bubble generator, each output port being connected to one or the other of said conduits.

The inclusion of said fluidic oscillator can provide a more efficient means of forming small bubbles in the liquid medium as described herein.

The bubbles preferably have an average diameter of no more than 10 mm, more preferably no more than 5 mm, even more preferably no more than 2 mm, especially no more than 1 mm, more especially no more than 0.5 mm, and most especially no more than 0.25 mm. The bubbles preferably have an average diameter of at least 0.1, preferably at least 0.5, preferably at least 1, preferably at least 2, preferably at least 5, preferably at least 10, preferably at least 20, preferably at least 30, and most preferably at least 40 microns.

Preferably, said bubbles have an average diameter of from about 0.1 microns to about 2 mm, more preferably from about 1 micron to about 1.0 mm.

The average diameter is preferably a volume average. As used herein, the average diameter preferably refers to the volume distributed parameter D(v,50).

In the present invention, preferably at least 50%, 60%, 70%, 80%, 90%, 95% or 99% of said bubbles have a diameter of no more than 10 mm, more preferably no more than 5 mm and especially no more than 2 mm. These percentages are preferably by volume (V %). Preferably, at least 1%, 5%, 10%, 20%, 30%, 40% and more preferably at least 50% of the bubbles have a diameter of greater than 0.1 microns, more preferably greater than 1 micron and especially greater than 10 microns. Again these percentages are preferably by volume (V %).

In the first and second aspects of the invention, the liquid medium is preferably an aqueous liquid medium. Thus, preferably, the liquid medium is or comprises water.

Preferably, the apparatus employs a voltage from about 1 mv to about 10,000V, more preferably from about 1V to about 5000V, even more preferably from about 50V to about 2000V, especially from about 100 to about 1000V, more especially from about 150 to about 450V and most especially about 170V. Preferably, the voltages are achieved by a capacitance-induced discharge.

In the present invention, the treatment chamber can comprise a rotatably mounted drum. The apparatus can comprise a housing containing said drum rotatably mounted therein.

The treatment chamber can comprise a tank with one or more spray nozzles. Said spray nozzles are preferably oriented such that in use the liquid medium can be directed towards the substrate. Preferably, the apparatus also comprises a pump and conduits such that the pump is able to supply the nozzles with liquid medium under pressure. Preferably, the treatment gas comprising ozone can be supplied into the apparatus within a conduit and/or within the tank itself. The tank may be fitted with one or more racks suitable for holding one or more dishwasher substrates, e.g. plates, pots and pans, glasses, cutlery and the like. Preferably, the nozzles are rotatably mounted such that in use they are able to rotate and spray the substrates with the liquid medium in many orientations. Such an apparatus is especially suitable as a dishwasher.

The substrate may be a hard or inflexible substrate. Examples of which include glass, metal, alloy, ceramic, wood and plastic substrates. These substrates may take the form of pots, pans, cutlery, plates, glasses, tubs, containers and the like. Such substrates are especially suitable when the apparatus is a dishwasher.

The drum can have a capacity from about 1 to about 40,000 litres, or from about 5 to about 10,000 litres or from about 10 to about 7000 litres, or from about 10 to about 700 litres, or from about 30 to about 150 litres.

In the present invention, the apparatus can comprise access means moveable between an open position wherein said one or more substrates can be placed within the treatment chamber and a closed position. In the closed position, the apparatus can be substantially sealed.

The apparatus can comprise one or more delivery means to introduce said liquid medium into the treatment chamber.

The apparatus of, or used in the methods of, the present invention comprises a multiplicity of solid particles. The multiplicity of solid particles is suitably provided for agitation with said one or more substrates in said treatment chamber. The apparatus can further comprise a storage compartment, such as a sump, to retain said solid particles. Said storage compartment can further comprise a liquid medium.

In the present invention, said bubble generator may be located in said treatment chamber.

In the present invention, said bubble generator may be located in said storage compartment.

The bubble generator can be located in the treatment chamber e.g. the drum or tank. The bubble generator can be located on or in lifters optionally present within the drum. The bubble generator can be located in or connected to one or more conduits which are in fluidic communication with the treatment chamber. Preferably, the bubble generator is located within the apparatus such that the time between generation of the bubbles and contact of the bubbles with the substrate is no more than 10 seconds, preferably no more than 5 seconds, preferably no more than 2 seconds and especially no more than 1 second. It will be appreciated that the bubble generator is supplied with a flow of the liquid medium at a suitable flow rate so as to achieve these desired times. The bubble generator can be located within or connected to a conduit proximate to the entry of the liquid medium into the treatment chamber. By proximate we preferably mean within no more than 100 cm, more preferably no more than 70 cm and especially no more than 50 cm from the point of exit of the liquid medium into the treatment chamber measured following the path of the liquid medium and bubbles.

The apparatus of, or used in the methods of, the present invention can comprise a first bubble generator located in said storage compartment, a second bubble generator located in said treatment chamber and one or more conduits to convey said treatment gas to said first bubble generator and said second bubble generator and wherein said first bubble generator and said second bubble generator are operable to form bubbles in said liquid medium, preferably wherein said bubbles have an average diameter of no more than 10 mm.

The apparatus of, or used in the methods of, the present invention can comprise pumping means configured to pump said multiplicity of solid particles into the treatment chamber. The solid particles can be pumped into the treatment chamber via one or more ducts.

The apparatus of, or used in the methods of, the present invention is suitably adapted to recirculate the solid particles along a recirculation path from the storage compartment to the treatment chamber.

Preferably, the multiplicity of solid particles comprises or consists of a multiplicity of polymeric particles, or a multiplicity of non-polymeric particles, or a mixture of a multiplicity of polymeric and non-polymeric particles. Thus the multiplicity of solid particles in embodiments of the invention can comprise exclusively polymeric particles, exclusively non-polymeric particles or mixtures of polymeric and non-polymeric particles.

Preferably, the multiplicity of solid particles comprises or consists of a multiplicity of polymeric particles.

Preferably, the polymeric particles are selected from particles of polyalkenes, polyamides, polyesters, polysiloxanes, polyurethanes or copolymers thereof.

The polymeric particles may comprise particles of one or more polar polymers. By polar we preferably mean that the polymer has carbon atoms bonded to one or more electronegative atoms, preferably selected from a halogen, oxygen, sulfur and nitrogen atoms.

Typically, the polymeric particles are selected from particles of polyamides, polyesters, polysiloxanes, polyurethanes or copolymers thereof, and preferably from polyamides or polyesters or copolymers thereof, and more preferably from polyamides.

Preferably, the multiplicity of solid particles is in the form of beads.

Preferably, the solid particles are reused one or more times in subsequent treatment processes for treating one or more subsequent batches of one or more substrates in, with or by said treatment apparatus.

Preferably, the apparatus is a washing machine. In these embodiments, the liquid medium can be wash liquor, preferably an aqueous wash liquor. The apparatus can be a domestic washing machine such as a machine configured for location in a private dwelling such as a house or apartment, or the washing machine can be a commercial washing machine. In such embodiments, the one or more substrates normally comprises a textile material, in particular one or more garments, linens, napery, towels or the like.

Alternatively, the apparatus can be a dishwasher. Thus the apparatus can be adapted to treat and/or clean one or more substrates in the form of culinary articles.

Alternatively, the said one or more substrates can be paper or cardboard and the like. Thus, the apparatus can be adapted for use in a paper or cardboard recycling process.

Particularly, the apparatus can be used in a de-inking process.

In a third aspect of the invention, there is provided a washing machine for cleaning one or more substrates, said washing machine comprising:

a housing containing a drum rotatably mounted therein wherein said drum is configured to receive wash liquor;
access means moveable between an open position wherein said one or more substrates can be placed within the drum and a closed position wherein the washing machine is substantially sealed;
a sump comprising a multiplicity of solid particles and wash liquor;
pumping means configured to pump said multiplicity of solid particles into the drum via one or more ducts;
a supply of a treatment gas comprising ozone; and
one or more conduits to convey said treatment gas to a bubble generator wherein said bubble generator is operable to form bubbles of said treatment gas in said wash liquor, preferably wherein said bubbles have an average diameter of no more than 10 mm.

Advantageously, a washing machine adapted for use with a multiplicity of solid particles and a bubble generator operable to form bubbles of ozone as described herein can enhance the treatment on the substrates contained therein. Without wishing to be bound by theory, the inventors consider that a synergistic interaction between the solid particles and ozone bubbles ultimately improves the cleaning effect imparted on the substrate.

The apparatus of said third aspect preferably further comprises:

a gas source to provide a feed gas comprising oxygen;
a plasma generator comprising electrodes, having a space between them which is preferably no more than 10 mm;
one or more delivery conduits to transport said feed gas from the gas source through the space between the electrodes;
a power source to apply a voltage across the electrodes to dissociate the oxygen to form said treatment gas comprising ozone.

Preferably, the electrodes present in the apparatus according to the third aspect of the present invention have a space between them of no more than 10 mm, more preferably no more than 5 mm, especially preferably no more than 2 mm and most preferably no more than 1 mm. Preferably, the electrodes present in the apparatus according to the third aspect of the present invention have a space between them of at least 0.001 mm, more preferably at least 0.01 mm and especially at least 0.1 mm.

In a fourth aspect of the invention, there is provided a washing machine for cleaning one or more soiled substrates comprising:

a housing containing a drum rotatably mounted therein, wherein said drum is configured to receive wash liquor;
access means moveable between an open position wherein said one or more soiled substrates can be placed within the drum and a closed position wherein the washing machine is substantially sealed;
a sump comprising a multiplicity of solid particles and wash liquor;
pumping means configured to pump said multiplicity of solid particles into the drum via one or more ducts;
a gas source to provide a feed gas comprising oxygen;
a plasma generator comprising electrodes, having a space between them which is preferably no more than 10 mm;
a delivery conduit to transport said feed gas from the gas source through the space between the electrodes;
a power source to apply a voltage across the electrodes to dissociate the oxygen to form a treatment gas comprising ozone; and
one or more conduits to convey said treatment gas to a bubble generator wherein said bubble generator is operable to form bubbles of said treatment gas in said wash liquor.

Advantageously, a washing machine comprising a plasma generator to form ozone and a bubble generator operable to produce bubbles of ozone enhances the cleaning effect on the substrates contained therein. Furthermore, an electrode spacing of no more than 10 mm, more preferably no more than 5 mm, especially no more than 2 mm and most especially no more than 1 mm advantageously allows miniaturization of the plasma generator, reduces its overall power consumption and facilitates ease of incorporation within the washing machine.

A preferred electrode spacing of at least 1 micron, more preferably at least 3 microns, especially at least 5 microns and more especially at least 10 microns works particularly effectively and permits time for ozone formation prior to the plasma becoming extinguished.

In the third and fourth aspects, the wash liquor is preferably water. The wash liquor preferably comprises at least one detergent composition and/or one or more additives as detailed further hereinbelow.

In a fifth aspect of the invention, there is provided a method of treating one or more substrates, the method comprising agitating said one or more substrates in a treatment formulation comprising a multiplicity of solid particles, a liquid medium and bubbles of ozone, preferably wherein said bubbles of ozone have an average diameter of no more than 10 mm (preferably no more than 1 mm).

Advantageously, agitating the substrates with a multiplicity of solid particles in combination with bubbles of ozone as described herein enhances the efficacy of the treatment of the substrates.

Preferably, said method further comprises pre-treatment of said multiplicity of solid particles with bubbles of ozone prior to contact of said particles with said substrate(s), preferably wherein said bubbles of ozone have an average diameter of no more than 10 mm. Said pre-treatment of the solid particles is preferably performed in accordance with the seventh aspect of the invention described hereinbelow. Thus, the method of the fifth aspect of the invention preferably comprises a step (A) of pre-treatment of said multiplicity of solid particles with bubbles of ozone prior to contact of said particles with said substrate(s), preferably wherein said bubbles of ozone have an average diameter of no more than 10 mm (preferably no more than 1 mm), and further comprises a step (B) of agitating said substrate(s) with a treatment formulation comprising said pre-treated multiplicity of solid particles, a liquid medium and bubbles of ozone preferably wherein said bubbles of ozone have an average diameter of no more than 10 mm (preferably no more than 1 mm). The ozone bubbles in step (B) are generated additionally to the ozone bubbles in step (A).

The treatment of the substrate(s) preferably is or comprises cleaning said one or more substrates. Thus, the substrates are typically soiled substrates. The inclusion of the multiplicity of solid particles referred to herein enables a mechanical action on the substrates which enhances cleaning of the substrates.

The treatment of the substrate(s) may comprise modifying or transforming the properties of said one or more substrates. The method can comprise bleaching and/or oxidizing the one or more substrates.

The treatment of the substrate(s) can comprise applying a shrink resist treatment to said one or more substrates, for instance keratinous substrates such as wool or woollen garments.

The substrate(s) preferably comprise a textile material, in particular one or more garments, linens, napery, towels or the like.

The treating of the substrate(s) can be a paper or cardboard recycling process or a de-inking process, and in such embodiments said one or more substrates can be paper or cardboard and the like.

In the method of the fifth aspect of the invention, said bubbles preferably have an average diameter as described hereinabove for the preceding aspects of the invention.

In the fifth aspect of the invention, the treatment formulation preferably comprises water.

The treatment formulation preferably comprises at least one surfactant.

The treatment formulation suitably comprises at least one detergent composition. The at least one detergent composition can comprise cleaning components and post-treatment components. Said cleaning components may be selected from the group consisting of: surfactants, enzymes and bleach. Said post-treatment components may be selected from the group consisting of: anti-redeposition additives, perfumes and optical brighteners.

The treatment formulation can further comprise at least one additive selected from the group consisting of: builders, chelating agents, dye transfer inhibiting agents, dispersants, enzyme stabilizers, bleach activators, polymeric dispersing agents, clay soil removal agents, suds suppressors, dyes, structure elasticizing agents, fabric softeners, starches, carriers, hydrotropes, processing aids and pigments.

The liquid medium can comprise wash liquor, preferably an aqueous wash liquor. The composition of the wash liquor may depend at any given time on the point which has been reached in the treatment cycle for the one or more substrates using the apparatus and/or method of the invention. Thus, for example, at the start of the treatment cycle, the wash liquor may be water. At a later point in the treatment cycle the wash liquor may include detergent and/or one of more of the above mentioned additives. If a cleaning stage is to be conducted during the treatment cycle the wash liquor may, for example, also include suspended soil and/or other contaminants removed from the one or more substrates.

Typical conditions for the treatment cycle are temperatures of from about 5 to about 95° C., preferably from about 10 to about 60° C. or from about 15 to about 40° C. Preferably, the duration of the treatment cycle is from about 5 to about 120 minutes in a substantially sealed system. Thereafter, additional time may be required for the completion of the rinsing and any further stages of the overall process. Typically, that the total duration of the entire cycle is from about 40 minutes to about 150 minutes, typically about 1 hour.

The method of the fifth aspect of the invention is particularly a method of cleaning one or more substrates soiled with stains having an enzymatic and/or bleachable component. As used herein, the term “enzymatic stain” preferably refers to stains selected from amylase-responsive, protease-responsive and lipase-responsive stains (particularly amylase-responsive and protease-responsive), including sebum, curry, vegetable fat/milk and cocoa. As used herein the term “bleachable stain” preferably refers to stains selected from curry and cocoa.

In the method of the fifth aspect of the invention, the solid particles are not intended to penetrate the surface of the substrate being treated or cleaned, and indeed the solid particles preferably do not penetrate the surface of the substrate being treated or cleaned

In a sixth aspect of the invention, there is provided a treatment formulation comprising: a multiplicity of solid particles, a liquid medium and bubbles of ozone preferably wherein said bubbles have an average diameter of no more than 10 mm (preferably no more than 1 mm).

In a seventh aspect of the invention, there is provided a method of preparing a multiplicity of solid particles for use in the treatment of one or more substrates, the method comprising a first step of: agitating said multiplicity of solid particles with bubbles of ozone in a liquid medium preferably wherein said bubbles have an average diameter of no more than 10 mm (preferably no more than 1 mm).

In the seventh aspect of the invention, said treatment is preferably a cleaning treatment. Preferably, said first step is conducted immediately prior to agitating said multiplicity of solid particles with said one or more substrates.

Advantageously, subjecting the multiplicity of solid particles to a treatment by agitation in a liquid medium with bubbles of ozone as described herein enhances the cleaning effect when said multiplicity of solid particles are subsequently used in the treatment of substrates. Furthermore, the above-mentioned preparation step can serve to sterilise the multiplicity of solid particles prior to their agitation with the substrates.

The method of the seventh aspect of the invention is suitably performed in the apparatus described hereinabove in respect of the first, second, third or fourth aspects and all features thereof are directly applicable for use in the method of the seventh aspect. Because the ozone bubbles are typically labile, the method of the seventh aspect of the invention is suitably performed as part of the treatment of said one or more substrates, i.e. as part of the treatment or wash cycle of said substrate(s). The bubble generator for the provision of ozone bubbles in said first step of the method of the seventh aspect of the invention may be the same as or different to the bubble generator for the provision of ozone bubbles in the treatment of said substrate(s), but it is preferably a different bubble generator. As described hereinabove, the apparatus can comprise a first bubble generator located in the storage compartment which retains said solid particles and a second bubble generator located in the treatment chamber or located in or connected to one or more conduit(s) in fluidic communication with the treatment chamber. Alternatively, the apparatus comprises a single bubble generator and a plurality of conduits to convey the liquid medium comprising ozone bubbles to the treatment chamber and the storage compartment.

Preferably, the duration of said first step in the seventh aspect of the invention is from about 5 minutes to about 60 minutes, preferably from about 5 minutes to about 30 minutes.

The ozone-treated multiplicity of solid particles may then be subsequently used in the treatment of substrates. Advantageously, pre-treatment of the solid particles results in: a reduction in the quantity of detergent used in subsequent treatment of substrates; sterilisation of the solid particles, treatment chamber and substrates; an improvement in stain removal (particularly enzymatic and bleachable stains); and an improvement in fabric colour care where fabric damage in coloured substrates is reduced.

In an eighth aspect of the invention, there is provided a method of inhibiting the growth or accumulation of bacteria in one or more internal components of a washing machine, the method comprising circulating a formulation comprising a liquid medium, bubbles of ozone and a multiplicity of solid particles within the interior of said washing machine, preferably wherein the bubbles have an average diameter of no more than 10 mm (preferably no more than 1 mm).

Advantageously, the invention provides an effective way of preventing build-up of bacteria and/or sterilising the interior of the washing machine as the liquid containing bubbles of ozone is circulated therethrough.

In the eighth aspect of the invention, advantageously, the circulation of a liquid medium and bubbles of ozone as described herein in combination with said solid particles can act in synergy to limit bacterial accumulation on the interior of the washing machine. The solid particles can, for example, exert additional mechanical action on the internal walls and/or surfaces of the washing machine.

It should be noted that features of said first aspect, said second aspect, said third aspect, said fourth aspect, said fifth aspect, said sixth aspect, said seventh aspect and said eighth aspect of the invention can be combined interchangeably and without limitation unless the context indicates otherwise. For instance, the description of the multiplicity of solid particles hereinabove is applicable to each of said first aspect, said second aspect, said third aspect, said fourth aspect, said fifth aspect, said sixth aspect, said seventh aspect and said eighth aspect of the invention.

Throughout the present disclosure, the liquid medium suitably is or comprises water, and preferably is water.

The multiplicity of solid particles as referred to herein is distinguished from, and should not be construed as being, a conventional washing powder (that is, laundry detergent in powder form). Washing powder is generally soluble in the wash water and is included primarily for its detergent qualities. The washing powder is disposed of during the wash cycle since it is sent to drain in grey water along with removed soil. In contrast, a significant function of the multiplicity of solid particles referred to herein is a mechanical action on the substrate which can enhance the treatment effect conveyed on the substrate.

### BRIEF DESCRIPTION OF THE DRAWINGS

The invention will now be further illustrated by reference to the following drawings, wherein:

FIG. 1 is a schematic illustration of a compartment of the treatment apparatus including the plasma generator in accordance with the invention;

FIG. 2 is a plan view of a suitable fluidic diverter to oscillate gas in accordance with the invention;

FIG. 3 is a bubble generator plate in accordance with the invention;

FIG. 4 is an end view showing the relative dimensions of the liquid and gas conduits of the bubble generator plate shown in FIG. 3;

FIGS. 5A and B are respectively a schematic perspective view of a diffuser employed in the invention and a side section showing bubble pinch off;

FIG. 6 is an illustration of a rounded conductor assembly for use in the treatment apparatus according to the invention;

FIGS. 7A, B, 8A, B, 9A, B and 10A, B are plan and side views respectively of the rounded conductor assembly of FIG. 6;

FIGS. 11A and B shows respective front and rear isometric views of a washing machine in accordance with the invention;

### DETAILED DESCRIPTION OF THE INVENTION

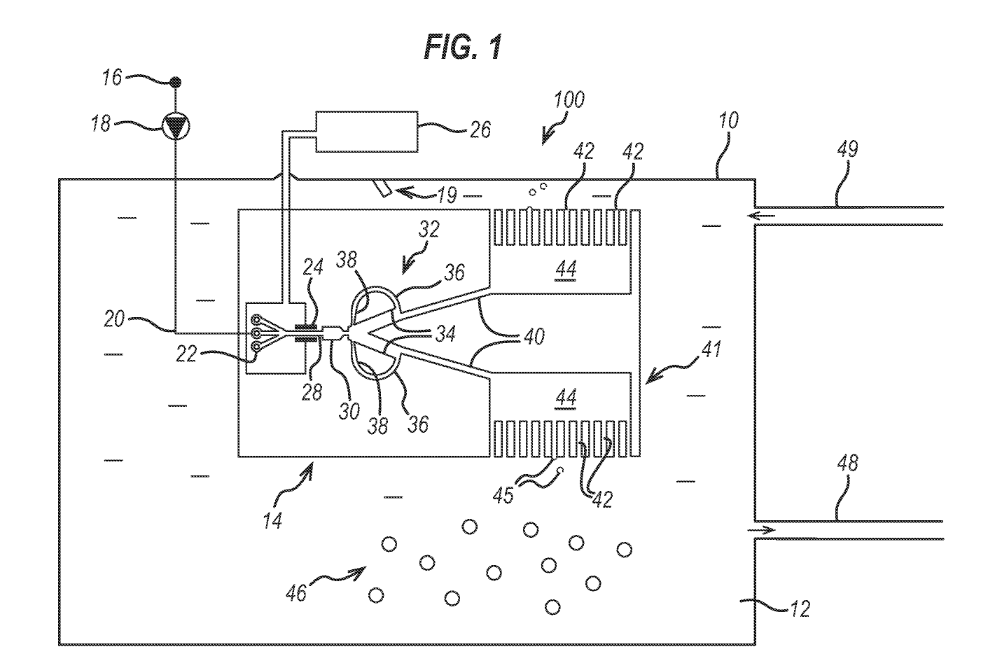

In FIG. 1, there is depicted an ozone treatment apparatus 100 including a compartment 10 containing a liquid 12 and a submerged ozone generator 14 supplied with gas from a source 16. A pump 18 pressurizes the gas, which is either pure oxygen or air including oxygen. The gas can be supplied under constant pressure. A conduit 20 leads the oxygen/oxygen-containing-air to the ozone generator 14, where it enters any one of multiple ports 22 before passing through a plasma generation chamber 28 between two electrodes 24. Multiple entry ports are generally preferred in the apparatus of the present invention described generically and specifically herein, since the inventors have found that the greater number of parallel entry points, the better the gas distribution. Electrodes 24 are contained within the unit 14, which is sealed to prevent the ingress of water. The electrodes 24 are supplied by a plasma source 26 comprising an impedance matching network. The gas enters the plasma generation chamber 28 at about atmospheric pressure between the electrodes 24 and is ionised to produce plasma therein. A distinct glow is produced having the absorption spectrum of ozone, showing that the ozone generator does indeed convert the oxygen in the gas supply 16 to ozone.

In any event, the output from the chamber 28 is a supply of gas and it exits a jet 30, which is a supply port of a fluidic diverter 32. The gas exiting jet 30 adheres to one of two walls 34 by the coanda affect. However, after a moment's flow attached to either wall, a branch 36 feeds back some of the flow to the relevant one of a pair of control ports 38. Flow from either port 38 detaches the flow from the wall 34 in which the port 38 exits, and diverts that flow to the other wall 34 against which it next adheres.

Accordingly, from each output 40 of the fluidic diverter 32 there is a pulsating flow of gas that is directed to a bubble generator 41. The outputs 40 each supply a separate series of openings 42 in the bubble generator 41, protected by large volume plenum chambers 44 so that bubbles 45 exit all the openings 42 side by side. By virtue of the pulsating flow, the bubbles break off at a much smaller volume than would otherwise be the case.

The apparatus described herein can include one or more features of the plasma generator and ozone generator described in WO-A-2010/079351, the contents of which are hereby incorporated by reference.

Furthermore, the compartment 10 as indicated in FIG. 1 can comprise an inlet duct 49 and an outlet duct 48. The respective inlet and outlet ducts 49, 48 can enable the liquid to enter and exit the compartment 10. Optionally, the compartment 10 can comprise one or more delivery means 19 that can introduce liquid or add further liquid to the interior of the compartment.

Additionally, the compartment 10 can further comprise a multiplicity of solid particles 46 dispersed throughout the liquid 12. Following the generation of the ozone plasma, the bubbles 45 formed in the liquid 12 are effectively dosed with ozone and a portion of the liquid 12 containing the ozone bubbles and the solid particles 46 can be transported from the compartment 10 via the outlet duct 48. Thus, compartment 10 can serve to store and retain the solid particles and liquid 12 before dosing with ozone from the ozone generator 14. The outlet duct 48 can thereby transport the ozone bubbles, liquid and solid particles to a treatment chamber for agitation with one or more substrates awaiting treatment. Alternatively, compartment 10 can itself serve as a treatment chamber, and thus can further comprise one or more substrates for treatment therein and be further adapted to enable agitation of the solid particles, liquid and ozone bubbles with the substrates.

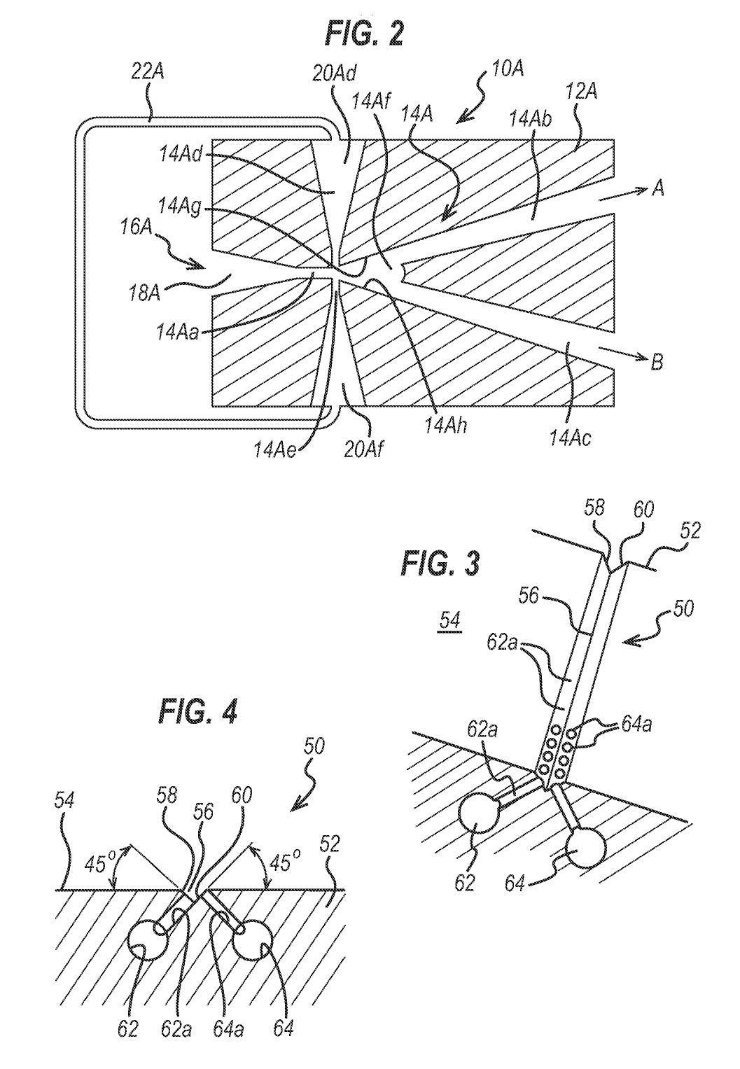

The bubble generator of the present invention can include one or more of the features described in WO-A-2008/053174, the contents of which are hereby incorporated by reference. Thus, the apparatus can comprise a fluidic diverter of the type specified in WO-A-2008/053174. An expanded version of the fluidic diverter utilised in FIG. 1 is thus shown in FIG. 2. A fluidic diverter 10A is shown in section, comprising a block 12A in which passages indicated generally at 14A are formed. An inlet passage 14Aa has a supply 16A of fluid under pressure connected thereto by an inlet port 18A. Two outlet passages 14Ab,Ac branch from the inlet passage 14Aa. Two control passages 14Ad,Ae oppose one another on either side of the inlet passage just in front of the branch 14Af between the two outlet passages 14Ab,Ac. The control passages are supplied by control ports 20Ad,Af which are interconnected by a closed loop conduit 22A. When fluid passes along the inlet passage 14Aa and enters the diverging branch 14Af it tends to cling to one side or the other under the influence of the Coanda effect, and preferentially enters one or other of the outlet passages 14Ab,Ac. In fact, the effect is so strong that, provided the pressure region upstream of the outlet passages 14Ab,Ac is favourable, more than 90% of flow in the inlet passage 14Aa will enter one or other of the outlet passages 14Ab,Ac. The outlet passages 14Ab,Ac are connected to respective outlet ports A,B.

If the flow is predominantly into outlet passage 14Ab, for example, then the flow of fluid follows closely wall 14Ag of the inlet passage 14Aa and across the mouth of control passage 14Ad, reducing the pressure in the passage accordingly by virtue of the venturi effect. Conversely, there is not so much flow adjacent control passage 14Ae. Consequently, a pressure difference is created in the control loop 22A and fluid flows from control port 20Af, around control loop 22A, and enters control port 20Ad. Eventually, the flow out of the control passage 14Ad becomes so strong that the flow from inlet passage 14Aa to outlet passage 14Ab detaches from the wall 14Ag containing the mouth of control passage 14Ad, and instead attaches on the opposite wall 14Ah, whereupon such flow is switched to passage 14Ac. Then, the opposite condition pertains, and the pressure in control port 14Ae is reduced, and grows in control port 14Ad, whereupon the flow in control loop 22A reverses also. The arrangement therefore oscillates, in known manner, dependent on several factors including the length of loop 22A, which length affects the inertia of the control flow and the speed with which it switches. Hence, the frequency of the oscillations may be adjusted by changing the length of said closed loop. Other factors including the geometry of the system, back pressure from the outlets and the flow through the fluidic diverter 10A also affect the frequency.

The arrangement shown in FIG. 2 conveniently comprises a stack of several Perspex™ plates each about 1.2 mm thick and laser cut with the outline shape of passage 14A. Top and bottom cover plates close and complete passage 14A and hold the stack together, the bottom (or top) one being provided with the ports 18A, 20Ad, 20Af, A, and B.

When measuring the variation of frequency of oscillation of one system employing air as the fluid in the fluidic diverter of FIG. 2 with a control loop of plastics material of 10 mm internal diameter and an airflow of 10 litres per minute, frequencies between 5 and 25 Hz can easily be achieved.

Thus, when the outputs A,B of fluidic diverter 10A are connected to an outlet opening into a liquid, finer bubbles are produced than when a steady flow rate of similar magnitude is employed. Moreover, because the bubbles are finer, fewer large bubbles are produced: they are detached sooner by virtue of the oscillating air supply.

The bubble generator can thus provide a conduit opening into a liquid wherein gas, specifically treatment gas comprising ozone, is passed along the conduit and the gas is oscillated as it passes along the conduit but without oscillating the conduit itself other than that caused by oscillation or reaction of the gas. The liquid is under pressure less than said gas and the oscillations are preferably effected by a fluidic oscillator such as fluidic diverter 32 or 10A.

Advantageously, the entire energy of the system is in oscillating the gas, and not the conduit through which it is passed, whereby the efficiency of the system can be maximised. Energy is not wasted in oscillating the conduit that delivers the treatment gas, said conduit having a much greater mass and consequently would require more energy to oscillate.

Preferably, said oscillations effected by the fluidic oscillator are effected at a frequency between 0.01 and 1000 Hz, more preferably between 0.1 and 500 Hz, even more preferably between 1 and 100 Hz, especially between 5 and 50 Hz and more especially between 10 and 30 Hz.

The volume flow of said oscillating gas is sufficient that a plurality of said conduits conveying treatment gas to the outlets of the bubble generator may be supplied simultaneously. Particularly, the volumetric flow rate for each cycle of oscillation can be sufficient to fill a bubble emanating from each conduit to at least hemispherical size before the oscillation is switched, so that all the bubbles have substantially the same size before being separated from the conduit or outlet by the break in pressure.

The bubble generator preferably comprises one or more bubble diffuser(s), preferably wherein said bubble diffuser is in combination with a fluidic diverter (for instance a fluidic diverter as illustrated in FIGS. 1 and 2).

In general terms, a bubble diffuser comprises a multiplicity of outlet ports to allow egress of the treatment gas into the liquid medium of the treatment chamber such that the treatment gas passes into the liquid medium in the form of a multiplicity of bubbles, preferably such that the average diameter of the bubbles is controlled by the dimensions of the outlet ports and the pressure of the treatment gas.

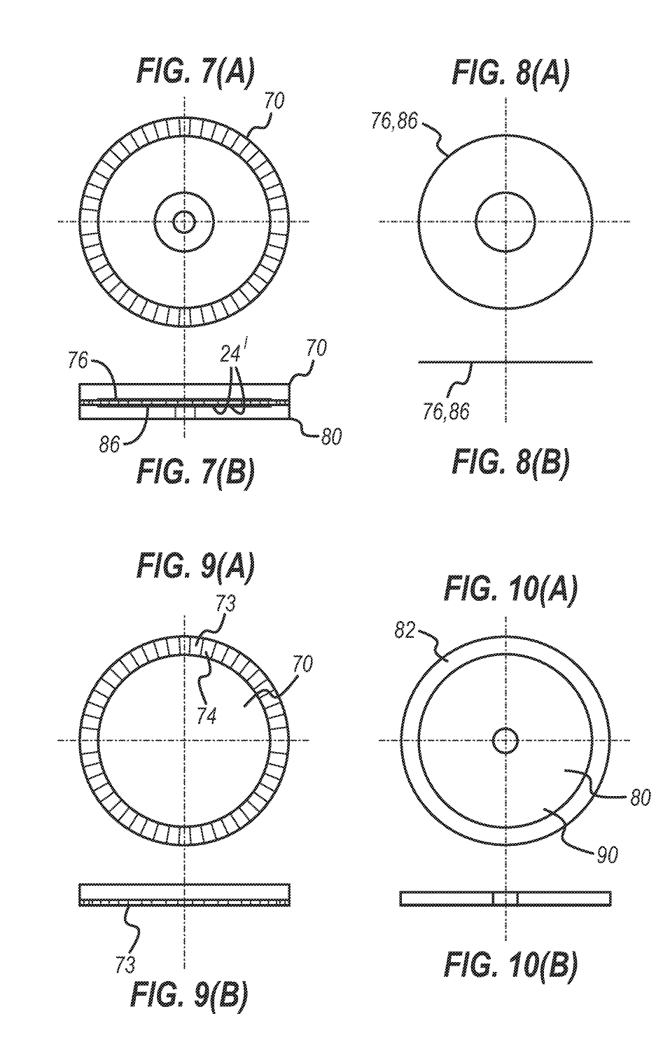

The bubble diffuser can comprise a polymer membrane (including polyvinylidene difluoride, polyether sulfone, polycarbonate, polyurethane and polyolefin (particularly polyolefin rubbers such as ethylene propylene diene monomer (EPDM) rubbers, particularly PTFE-coated EPDM and fluorinated EPDM) polymer membranes), a porous ceramic membrane, a metallic or alloy (e.g. steel) membrane (for instance perforated or sintered), a porous glass membrane (e.g. a sintered glass membrane), or a carbon or glass fibre or a metal or alloy wire mesh. The bubble diffuser may be of the type described on page 12, lines 14 to 26 of WO-A-2008/053174 and with respect to FIGS. 7 and 8, the disclosure of which is incorporated herein by reference.

Preferably, the treatment gas is under slight pressure so that bubbles are more easily formed by the bubble generator. Preferably, the pressure of the treatment gas in the bubble generator is at least 1 bar, more preferably at least 1.1 bar, and especially at least 1.2 bar. The pressure is preferably no more than 10 bar, more preferably no more than 8 bar, especially no more than 6 bar, even more especially no more than 5 bar, yet more especially no more than 4 bar and most especially no more than 3 bar.

Thus, it is preferred that the pressure of the treatment gas in the bubble generator is greater than the liquid medium in the treatment chamber of the apparatus.

The bubble diffuser preferably comprises pores. The pores in the bubble diffuser preferably have an average diameter of no more than 10 mm, more preferably no more than 5 mm, even more preferably no more than 2 mm, especially no more than 1 mm, more especially no more than 0.5 mm, even more especially no more than 0.25 mm and most especially no more than 0.1 mm.

The pores in the bubble diffuser preferably have an average diameter of at least 0.1, 0.5, 1, 2, 5, or at least 10 microns. Preferably, said pores in the diffuser have an average diameter of from about 0.1 microns to about 2 mm, more preferably from about 1 micron to about 1.0 mm, especially from 1 micron to 250 microns. A particularly preferred diffuser has pores with an average diameter of from 1 to 100 microns.

The pore size is preferably measured by Scanning Electron Microscopy (SEM). If the pores are not round or circular, image analysis can be used to calculate the area of the pore and then this can be converted into an effective diameter for a pore of a hypothetically circular shape having the same area. The average is preferably a number average. The average is preferably taken from at least 100 and more preferably at least 1000 pores.

The pores in the diffuser can have a range of pore sizes or the pore size of each pore can be substantially all the same (monomodal pore sizes). For the purposes of this invention the diffuser is regarded to have monomodal pore sizes if 90% of the total pores by number have a size which is within +/−10% of the size of the mean pore size. Monomodal pore sizes can be formed especially readily using laser ablation.

The bubble diffuser can also be an electrode. This permits the treatment gas to exit the diffuser/electrode with other active and short lived plasma by-products. In such cases, the diffuser/electrode is preferably a conductive material such as a metal, alloy or composite. This arrangement further improves the energy efficiency.

It will be appreciated that the bubble generator, and the bubble diffuser where present, are adapted to prevent the liquid medium of the treatment chamber (for instance, the wash liquor of the washing machine described herein) flowing into the plasma generator.

The apparatus described herein preferably also comprises one or more ozone monitors, which may be located inside and/or outside the treatment chamber, such that the apparatus, and particularly the plasma generator, may be shut down if ozone levels exceed a certain threshold, for instance 0.2 ppm.

The present invention provides arrangements to enable the formation of both very small ozone bubble sizes and with a very even size distribution. One phase of the oscillating gas may be employed to drive liquid across the outlet of the conduit containing said treatment gas after formation of a bubble in the other phase of oscillation, whereby the bubble is detached by the force of said driven liquid. Preferably, this is provided by the arrangement described above in relation to the fluidic diverter where the conduits of each output are arranged facing one another at an inclined angle, preferably at right angles, with respect to one another, one output being maintained filled with the liquid. Thus, while the first output fills a bubble at the mouth or outlet of its conduit, on the second phase, liquid is driven out of the other conduit knocking off the bubble formed on the first conduit. The arrangement is especially suitable when a plurality of conduits, that is gas conduits, are supplied in parallel from one output, a similar plurality of conduits, that is, liquid conduits, being disposed opposite the gas conduits and supplied in parallel by the other output. The bubbles on the gas conduits will all be stably formed of approximately equal size provided they do not much exceed hemispherical in size, and can be knocked off sooner than would be the case without the impetus of the liquid driven by the liquid conduits. Such an arrangement is conveniently referred to as a knock-off system, as the bubbles are knocked off their attachment to the aperture forming them.

A suitable arrangement for the knock-off system can comprise a plate having two parallel manifolds parallel a surface of the plate in contact with the liquid and supplied by respective outputs of the fluidic diverter, a trench in the surface and disposed between and parallel the manifolds, and conduits leading from opposed sides of the trench into said manifolds. Preferably, the trench is V-shaped. Preferably, the V-shaped trench is right-angled.

An appropriate arrangement is shown in FIGS. 3 and 4, wherein the bubble generator of the invention further comprises an alternative diffuser arrangement. Diffuser 50 comprises a plate 52 having a top surface 54 in which a right-angled groove 56 is formed, with each of its sides 58,60 being angled at 45° to the top surface 54. Under the surface but parallel thereto are two supply passages 62,64 also lying parallel, and disposed one on either side of, the groove 56. Rising up from each passage are a plurality of ports 62a,64a. Ports 64a are relatively narrow and open in the middle of the face 60 of the groove 56. Ports 62a are relatively broad and open at the base of the groove 56. There are as many ports 62a as there are ports 64a, and each port 62a is arranged opposite a corresponding port 64a. Moreover, the passage 62 and the ports 62a are arranged so that the direction of discharge of fluid from port 62a is parallel the face 60 of the groove 56.

Passage 62 may be larger than passage 64, but the ports 62a are certainly larger than the ports 64a. The reason for this is that the passage 62 is arranged to carry liquid, the liquid in which the diffuser 50 is sited. The passage 64, on the other hand, carries gas. The arrangement is such that the diameter of the gas port 64a is small, according to the desired size of bubble to be formed, and for instance as small as 0.25 mm or less depending on the technique employed to form the port 64a. In Perspex™-type material, the holes can be drilled mechanically to about 0.25 mm, but other methods exist to make smaller holes if desired.

The arrangement shown in FIGS. 3 and 4 can be employed in combination with an apparatus comprising a fluidic diverter of the type shown in FIG. 1 or 2 such that a pulse of liquid can be issued from the mouth of each port 62a and be directed against the side of bubbles on the ports 64a to knock them off. The bubbles so formed are therefore very small, or at least much smaller than they would otherwise be, and of very even size distribution.

In this respect, the material of the surface through which the conduit conveying the treatment gas is formed is preferably non-wettable by the gas, so that the bubble does not tend to stick to it. Glass is a suitable material in this respect, although other materials such as Teflon® are also suitable.

The bubble generator can comprise a chamber connected to said conduit carrying the treatment gas having a porous wall separating said chamber from the liquid and comprising a plurality of apertures formed in said wall. The wall may be metal, for example sintered metal in which said apertures are pores in said metal. Alternatively, the wall may be a porous ceramic and the apertures being the pores of said ceramic. Bubbles of treatment gas can thus be formed in the liquid via said apertures.

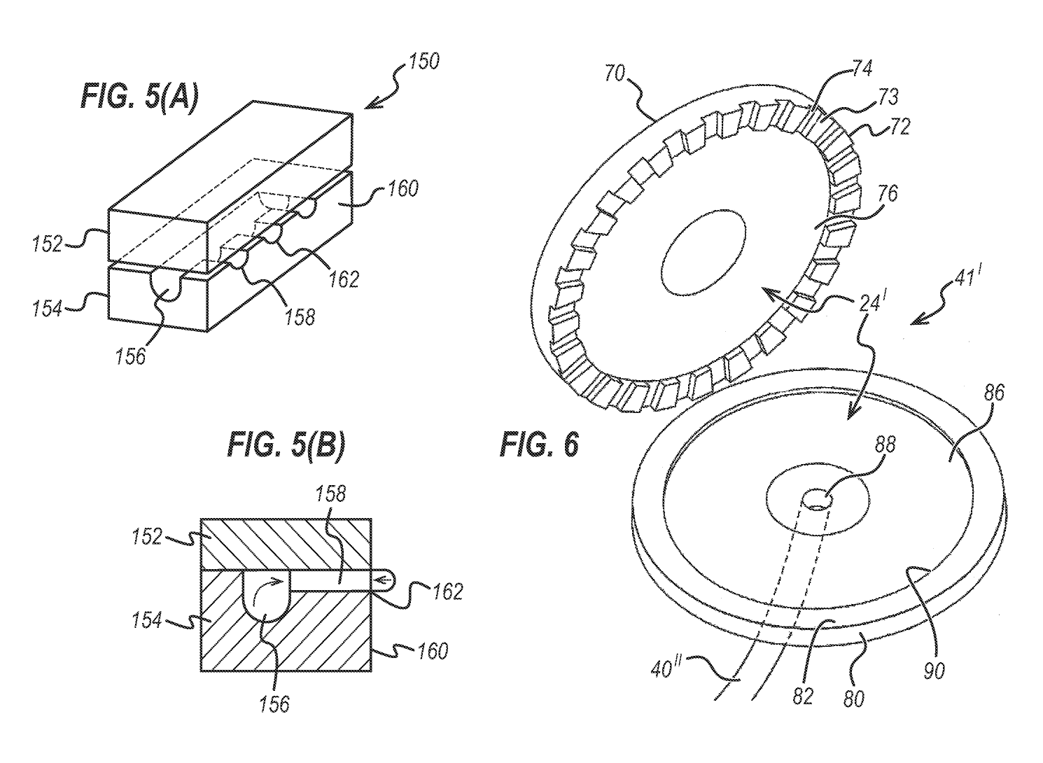

A further diffuser type that can be employed in the invention is shown in FIG. 5. Here, a glass diffuser 150 is constructed from two sheets of glass 152,154 adhered face to face, in which, on one sheet 154, channels 156,158 have been etched, so that, when connected as shown, a large conduit 156 is formed from which several smaller conduits 158 depend and emerge at surface 160 of the diffuser 150. In use, when connected to one branch of a fluidic diverter (such as that shown in, and described above with reference to FIG. 1 and FIG. 2), bubbles are formed at the openings 162 of each conduit 158. If the channels 158 are approximately 60 microns in depth and width, bubbles of a corresponding diameter are pressed from the conduits 158. If the gas flow is oscillated as described above, bubbles of that size break off. However, if the face 160 is rendered horizontal, it is, in fact, possible for bubbles much larger than that to be formed, circa. 500 microns diameter, with surface tension managing to adhere the bubble to the opening and it merely growing, albeit oscillatingly, until finally the mass of liquid displaced detaches the bubble. However, when the face 160 is oriented vertically, as shown in FIGS. 5A and B, the rebounding bubble in the first or second oscillation does not fit squarely against the opening but is distorted upwardly by gravity, and this results in the bubble pinching off much sooner. This is particularly the case if the material of the diffuser 150 is non-sticky, as far as the gas, is concerned, and this is the case for glass where the gas is air. Likewise for non-stick materials such as Teflon®. Thus, with such an arrangement, bubbles of the order of 50 to 100 microns can be produced.

Thus, from the foregoing, it can be seen for an apparatus comprising a given fluidic oscillator and/or bubble generator, the characteristics of the bubbles formed can be tuned accordingly. The flow rate and oscillation frequency of the fluidic oscillator are easily adjustable on-site, meaning that the most ideal arrangement of bubble generation (i.e. size and distribution) can be tuned for the particular circumstances whereby the most appropriate size and spatial distribution of bubbles can be adjusted.

In the treatment apparatus of the invention, a fluidic oscillator, such as the fluidic diverter 32, may be absent, although this is less preferred. In such embodiments, treatment gas comprising ozone can be conveyed to a suitable bubble generator without oscillation. Instead, small bubbles can be formed by other means known to those skilled in the art. For example, said bubbles can be formed using a bubble diffuser comprising frits, apertures or membranes adapted to produce bubbles of the appropriate size. Suitable bubble diffusers are described elsewhere herein and suitably comprise a polymer membrane (including polyvinylidene difluoride, polyether sulfone or polycarbonate polymer membranes), porous ceramic membrane, a perforated metal or alloy (e.g. steel) membrane, a porous glass membrane, or a carbon or glass fibre or a metal or alloy wire mesh.

The apparatus is configured such that the average diameter of the bubbles so formed is as described hereinabove.

Another preferred arrangement for the ozone generator 14 is shown in FIG. 6 where the electrodes 24 are built into the bubble generator 41′, in the form of a rounded conductor assembly. Here, a round cover 70 is constructed from insulating material and is provided with a slotted rim 72 in which there are multiple slots 74 disposed around the periphery of the of the rim 72. Suitably, the slots are present in the region of the outlet of the generator. Within the rim 72 is disposed a thin annular disc-like conductor 76 that forms one of the electrodes 24′. A second circular cover 80 has a plain rim 82, but contains a second annular conductor disc 86. The cover 80 is provided with a central aperture 88 to receive a supply of pulsating oxygen or oxygen-containing-air from one of two branches 40″ of a fluidic diverter (not shown).

In use, covers 70, 80 are butted against one another, with the slotted rim 72 abutting the plain rim 82, and thereby circumscribing a plurality of outwardly radiating channels 74. The height of the teeth 73 defines the width of the slots/channels 74 and is such that the separation of the conductors 76, 86 is less than 1 millimetre. Electrical connections (not shown) connect the plasma source (not shown) to the conductors 76, 86 so that a plasma develops in the space between them. Because of the large plenum defined by plasma generation chamber 28 between the electrodes 76,86 the pressure behind each of the channels defined by the slots 74 is equal. This ensures even bubble generation around the periphery of the rounded conductor assembly 41′.

Suitable covers are shown in FIGS. 7A,B, 8A,B, 9A, B and 10A,B. Typically, the covers 70, 80 have an outside diameter of about 36 millimetres, with the rim having an internal diameter of 30 millimetres. Thus, the length of the channels produced by the slots 72 are typically about 3 millimetres in length. The height of the teeth 73 is typically about 0.8 millimetres, so this represents the separation between the electrodes 76,86. Indeed, the cover 80 has a shallow pit 90 typically of about 0.2 millimetres depth, which is the same as the thickness of the electrodes 76,86.

In the aforementioned embodiments comprising electrodes and those incorporating the plasma generation chamber 28, the electrodes can have a space between them of no more than 10 mm and preferably from about 10 to about 1000 microns, as described herein. Particularly, the electrodes may be about 800 microns apart. The electrodes are typically about 1 centimetre long. The electrodes may be part of a bespoke microchip microfabricated by electrode position of copper on the sidewalls at the center of the microchannel over a length of 1 cm. Masking precludes deposition elsewhere on the microchannel surfaces, particularly the microchannel floor. The fabrication can be the modification of a standard base Micronit chip produced by MICRONIT MICROFLUIDICS BV, of the Netherlands.

A suitable plasma source 26 and associated circuit plus impedance matching network for the plasma generator and ozone treatment apparatus described herein is disclosed in WO-A-2010/079351. Specifically, the apparatus can incorporate the plasma source and circuit described on page 13, line 14 through to page 14, line 15 of WO-A-2010/079351 and with reference to FIGS. 8a and b.

As previously outlined, the ozone treatment apparatus can comprise a power source to apply a voltage across the electrodes to dissociate a feed gas comprising oxygen to form a treatment gas comprising ozone. The dissociation of the feed gas can occur to create a plasma comprising an intermediate ion wherein the treatment gas comprising ozone results from the recombination of intermediate ions. Furthermore, the reaction time T to reach 95%, preferably 99%, of the equilibrium conversion of said intermediate ion to said treatment gas comprising ozone is less than the ambipolar diffusion time Dt for the bulk of the ions to traverse the distance from one electrode to another, estimated by the relationship: Dₜ=d²/Dₐ where d is the gap distance between the electrodes, or the delivery conduit in the region of the electrodes, whichever is smaller, and Da is the ambipolar diffusivity of the plasma. Ambipolar diffusivity is a well understood quality of a plasma, whose value is dependent on several parameters of the plasma given by the expression: Da=Di (1+Te/Ti) where Di is the diffusivity of the ions and the ratio Te/Ti is the ratio of electron to ion temperatures. Basically, it is the speed of diffusion of the ions in a neutral field, but multiplied by a factor due to the consequence of the electric field generated by the movement of the electrons of the plasma.

Preferably, the voltage V is an alternating voltage whose frequency f of oscillation is between 10/T and 1/(10 T). Preferably, the frequency f is between 2/T and 1/(2 T). A frequency of 1/T appears to equate approximately the reaction period of the system with the energising voltage pulses. The frequency of the alternating voltage may be between 10 and 1000 Hz for a typical system, conveniently about 100 Hz.

As noted above, the electrodes 24 are separated by a distance d which is relevant with respect to the field strength between them, and hence the development of the plasma. However, if the delivery conduit carrying the feed gas and plasma is disposed between the plates, as shown in FIG. 1, then the dimension d to be used in the relationship Dₜ=d²/Dₐ is not the distance between the electrodes, but rather the internal dimension of the conduit. The reason for this is that ions will extinguish on the walls of the conduit, so that the reaction time T to reach the equilibrium conversion of the intermediate ions to the product gas needs to be less than the ambipolar diffusion time Dₜ given by the above relationship using the dimension of the conduit, and not the electrodes. Incidentally, for practical purposes, 95%, or preferably 99%, equilibrium conversion is employed as the target limit, since 100% equilibrium is probably never reached.

The advantages associated with the use of a plasma generator of the type as previously outlined for the production of ozone are based on the realisation that the speed of reaction between oxygen ions to form ozone, is much faster than the rate of extinction of oxygen ions and protons by collision with the walls of the conduit and/or electrodes. Consequently, despite the proximity of the electrodes with respect to one another (or the walls of the conduit if that is between the electrodes), the production of ozone is largely unaffected. Furthermore, given the proximity of the electrodes on the micro scale, the voltage needed to provide adequate electric field strength sufficient to dissociate oxygen is very much reduced, meaning that the expense of generating and confining high power voltages can be avoided. Furthermore, the apparatus can operate at or about atmospheric pressure, which is also rendered possible by proximity of the electrodes.

The avoidance of high voltage has the effect of reducing the power consumption, thereby rendering the process energy cost-effective. The requisite electron density is maintained simply because the electric field density can be relatively increased by virtue of the small separation of the electrodes and even at relatively low voltages.

Power usage may be cut by as much as a factor of ten for the generation of ozone. Indeed, a capacitance-induced discharge at 170V is sufficient to maintain a steady glow in an oxygen fed plasma, operating at 60 Hz. Preferably, the voltage is between 1 mV and 10,000V, more preferably between 1V and 5000V, even more preferably between 50V and 2000V, especially between 100 and 1000V and most especially between 150 and 450 V.

The treatment apparatus of the present invention is preferably a cleaning apparatus. Preferably, said cleaning apparatus is a washing machine.

Aqueous cleaning processes are a mainstay of conventional domestic and industrial textile fabric cleaning methods. On the assumption that the desired level of cleaning is achieved, the efficacy of such conventional processes is usually characterised by their levels of consumption of energy, water and detergent. In general, the lower the requirements with regard to these three components, the more efficient the washing process is deemed. The downstream effect of reduced water and detergent consumption is also significant, as this minimises the need for disposal of aqueous effluent, which is both extremely costly and detrimental to the environment.

In the view of the above-noted challenges associated with aqueous washing processes, the cleaning apparatus of the present invention incorporates a multiplicity of solid particles. The inclusion of said solid particles provides a means to improve mechanical action in the wash cycle to enhance the cleaning effect but without increasing the water level used. Hence the use of a multiplicity of solid particles in the cleaning apparatus can eliminate the requirement for the use of large volumes of water, but is still capable of providing an efficient means of cleaning and stain removal, whilst also yielding economic and environmental benefits.

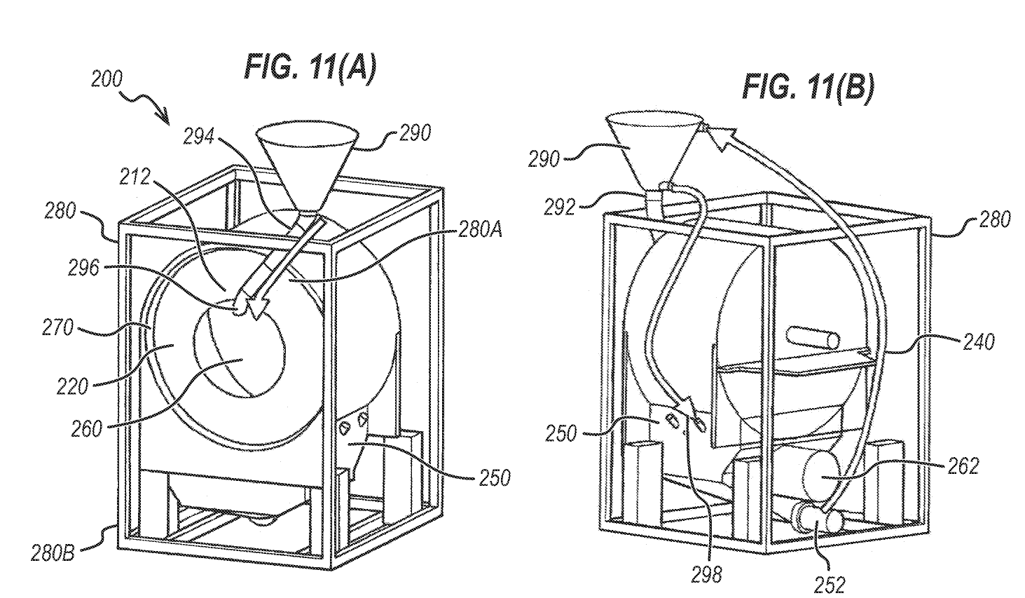

Referring now to FIGS. 11A and B, there is provided a cleaning apparatus 200 comprising a housing 280. The housing 280 can comprise an upper portion 280A and a lower portion 280B. The housing 280 further comprises therein a rotatably mounted drum 260. The drum 260 can be in the form of a rotatably mounted cylindrical cage. The drum 260 is suitably located in the upper portion of the housing 280A. The drum 260 is suitably mounted in a casing or tub 270. The tub 270 can circumferentially surround a portion of the drum 260 and can store wash liquor.

The cleaning apparatus 200 is designed to operate in conjunction with one or more substrates, a liquid medium and a multiplicity of solid particles suitably comprising a multiplicity of polymeric or non-polymeric particles. These polymeric or non-polymeric particles can be efficiently circulated to promote effective cleaning and the cleaning apparatus 200, therefore, can include circulation means. Thus, the inner surface of the drum 260 can comprise a multiplicity of spaced apart elongated protrusions affixed essentially perpendicularly to said inner surface. Said protrusions may additionally comprise air amplifiers which are typically driven pneumatically and are adapted so as to promote circulation of a current of air within said drum. Typically said cleaning apparatus 200 can comprise from 3 to 10, preferably 4, of said protrusions, which are commonly referred to as lifters.

The drum 260 can comprise perforated side walls (perforations not shown), wherein said perforations comprise holes have a diameter of from 2 to 25 mm or from 2 to 10 mm or a diameter of no greater than 5 mm or no greater than 3 mm.

Said perforations may permit the ingress and egress of fluids and fine particulate materials of lesser diameter than the holes, but are adapted so as to prevent the egress of said multiplicity of solid particles. Alternatively, said perforations permit the ingress and egress of fluids and said solid particles.

The cleaning apparatus 200 suitably comprises a door 220 to allow access to the interior of the drum 260. The door 220 can be moveable between an open and a closed position. When the door 220 is moved to an open position, access is permitted to the inside of the drum 260. When the door 220 is moved to a closed position, the cleaning apparatus 200 is substantially sealed.

The drum 260 can be mounted about an essentially horizontal axis within the housing 280. Consequently, in such embodiments of the invention, said door 220 is located in the front of the cleaning apparatus 200, thereby providing a front-loading facility.

Rotation of said drum 260 can be effected by use of drive means 262, which typically can comprise electrical drive means, in the form of an electric motor. Operation of said drive means 262 can be effected by control means which may be operated by a user. The cleaning apparatus can be used for paper or cardboard recycling and/or de-inking. The cleaning apparatus can be used for the cleaning of animal substrates such as those comprising hides, pelts or skins, especially for cleaning of cattle or cow hides. The cleaning apparatus can be used for cleaning leather and leather intermediates or precursors. The cleaning apparatus can be used to clean plastic, e.g. as part of plastics recycling. The cleaning apparatus can be used to clean metals and alloys, e.g. as part of recycling, surface passivation or coating processes.

The cleaning apparatus 200 can be a commercial washing machine (sometimes referred to as an industrial washer-extractor). Said drum 260 is suitably of the size which is to be found in commercially available washing machines and tumble driers, and can have a capacity in the region of 10 to 7000 litres. A typical capacity for a domestic washing machine would be in the region of 30 to 150 litres whilst, for an industrial washer-extractor, capacities anywhere in the range of from 150 to 7000 litres are possible. A typical size in this range is that which is suitable for a 50 kg washload, wherein the drum has a volume of 450 to 650 litres and, in such cases, said drum 260 would generally comprise a cylinder with a diameter in the region of 75 to 120 cm, preferably from 90 to 110 cm, and a length of between 40 and 100 cm, preferably between 60 and 90 cm.

The cleaning apparatus 200 can be a domestic washing machine. Typically said domestic washing machine can comprise a drum 260 having a capacity of from 30 to 150 litres, or from 50 to 150 litres. Generally, the drum 260 of said domestic washing machine will be suitable for a 5 to 15 kg washload. In such embodiments, the drum 260 can typically comprise a cylinder with a diameter in the region of 40 to 60 cm and a length in the region of 25 cm to 60 cm. The drum 260 typically exhibits 20 to 25 litres of volume per kg of washload to be cleaned.

The housing 280 or cabinet of the washing machine can have a length dimension of from about 40 cm to about 120 cm, a width dimension of from about 40 cm to about 100 cm and a height of from about 70 cm to about 140 cm.

The housing 280 or cabinet of the washing machine can have a length dimension of from about 50 cm to about 70 cm, a width dimension of from about 50 cm to about 70 cm and a height of from about 75 cm to about 95 cm; or a length dimension of about 60 cm, a width dimension of about 60 cm and a height of about 85 cm. The washing machine can be comparable in size to a typical front-loading domestic washing machine commonly used in the Europe.

The housing 280 or cabinet of the washing machine can have a length dimension of from about 50 cm to about 100 cm, a width dimension of from about 40 cm to about 90 cm and a height of from about 70 cm to about 130 cm; or a length dimension of from about 70 cm to about 90 cm, a width dimension of from about 50 cm to about 80 cm and a height of from about 85 cm to about 115 cm; or a length dimension of from about 77.5 cm to about 82.5 cm, a width dimension of from about 70 cm to about 75 cm and a height of from about 95 cm to about 100 cm; or a length dimension of about 71 cm (28 inches), a width dimension of about 80 cm (31.5 inches) and a height of about 96.5 cm (38 inches). The washing machine can be comparable in size to a typical front-loading domestic washing machine commonly used in the USA.

The cleaning apparatus 200 can comprise lifters which can collect the solid particles and transfer them to a lower portion of the housing 280B. Particularly said lifters can facilitate transportation of the multiplicity of solid particles to a sump 250 in said lower portion of the housing 280B.

In operation, agitation is provided by rotation of said drum 260 of said cleaning apparatus 200. However, there may also be provided additional agitating means, in order to facilitate the efficient removal of the multiplicity of solid particles at the conclusion of the cleaning operation. Said agitating means can comprise an air jet.

The cleaning apparatus 200 can comprise at least one delivery means 212. The delivery means 212 can facilitate the entry of wash liquor constituents (notably water and/or cleaning agents) directly (that is, otherwise than by way of the sump 250 and pumping means 252 as herein described below) to the drum 260 as required. The cleaning apparatus 200 may comprise a multiplicity of delivery means. Suitable delivery means can include one or more spraying means such as a spray nozzle. The delivery means 212 can deliver, for example, water, one or more cleaning agents or water in combination with said one or more cleaning agents. The delivery means 212 may be adapted to first add water to moisten the substrate before commencing the wash cycle. The delivery means 212 may be adapted to add one or more cleaning agents during the wash cycle. The delivery means 212 can be mounted on a portion of the door 220.

The housing 280 can include standard plumbing features, in addition to said delivery means, by virtue of which at least water and, optionally, cleaning agents such as surfactants, can be circulated and prior to their introduction to the drum 260.

The cleaning apparatus 200 can additionally comprise means for circulating air within said housing 280, and for adjusting the temperature and humidity therein. Said means may typically include, for example, a recirculating fan, an air heater, a water atomiser and/or a steam generator. Additionally, sensing means can also be provided for determining, inter alia, the temperature and humidity levels within the cleaning apparatus 200, and for communicating this information to control means which can be worked by an operative.

The lower portion of the housing 280 suitably includes a sump 250 which may function as a chamber for retaining the multiplicity of solid particles. The sump 250 can further contain water and/or one or more cleaning agents. The sump 250 can be enlarged in comparison to those found in conventional domestic washing machines to maximize the capacity for retention of the solid particles. The sump 250 can further comprise heating means allowing its contents to be raised to a preferred temperature for use in the cleaning operation. The heating means can comprise one or more heater pads attached to the outer surface of the sump 250.

The cleaning apparatus 200 further comprises a plasma generator and bubble generator as outlined above. The cleaning apparatus 200 may comprise an arrangement similar to that shown in FIG. 1 wherein the compartment 10 equates to the sump 250. In these embodiments the plasma generator and bubble generator components can be located in the sump 250 such that ozone bubbles are first produced in the liquid contained within the sump 250. Alternative arrangements include those whereby plasma is generated at a location remote to the sump 250 prior to transportation of the treatment gas via one or more conduits to a bubble generator residing in the sump 250 to thereby form ozone bubbles in the liquid contained therein.

In embodiments wherein ozone bubbles are generated in the sump 250, liquid containing said ozone bubbles and/or said solid particles can be pumped to another portion of the apparatus. For example, and with reference to FIG. 11B and FIG. 1, the liquid containing ozone bubbles can be transferred from the sump 250 through the outlet duct 48 and to the drum 260 via pumping means 252.

In the instance where ozone bubbles are produced in the sump 250 together with the multiplicity of solid particles, the solid particles can effectively be pre-treated before their subsequent agitation with the substrates in the drum. The inventors have discovered that pre-treatment of the solid particles with ozone bubbles can have several advantages. Firstly, pre-treatment of solid particles with ozone bubbles prior to their introduction to the drum can serve to reduce any bacterial build up and/or sterilize the particles before they contact the substrates contained in the drum. Secondly, pre-treatment of the solid particles can enhance the treatment effect following introduction of the solid particles into the drum and agitation with the substrates. Particularly, a notable enhancement of the cleaning effect on the substrates is possible.

The cleaning apparatus 200 can comprise an arrangement similar to that shown in FIG. 1 wherein the compartment 10 equates to the drum 260. In these embodiments, the plasma generator and bubble generator components may be located in the drum 260 such that ozone bubbles are generated in the liquid contained within the drum 260. Alternative arrangements include those whereby plasma is generated at a location remote to the drum 260 prior to transportation of the treatment gas via one or more conduits to a bubble generator residing in the drum 260 to thereby form bubbles in the liquid contained therein.

The cleaning apparatus 200 can be adapted to facilitate generation of ozone bubbles a plurality of locations. For example, ozone bubbles can, in some embodiments, be generated in both the sump 250 and the drum 260. This could be facilitated by, for example, providing a plurality of conduits to transfer treatment gas comprising ozone to a plurality of bubble generators. A first conduit can thus convey treatment gas comprising ozone to a first bubble generator at a first location and a second conduit can convey treatment gas to a second bubble generator at a second location. In some embodiments the first and second locations can be the sump and the drum respectively. In the above arrangement, ozone is suitably generated from a single source as previously described, before its distribution to the liquid medium in different locations within the apparatus via a plurality of bubble generators. Alternatively, a plurality of plasma generators and a plurality of bubble generators can be provided in desired locations within the apparatus.

The ozone generating apparatus may comprise an arrangement wherein the electrodes of the plasma generator are built into the bubble generator.

The cleaning apparatus described herein contains wash liquor. As described herein, “wash liquor” pertains to a liquid medium that can comprise water or water when combined with at least one cleaning agent such as a detergent composition and/or any further additives as detailed further hereinbelow. Thus the liquid in the sump 250 and the drum 260 can consist of wash liquor which can comprise varying amounts of water and detergent.

The cleaning apparatus can comprise pumping means 252 to pump wash liquor and the solid particles. Pumping means 252 can be located in the lower portion of the housing 280B. Particularly, the pumping means 252 can be located in or can be connected to the sump 250. The pumping means 252 can be adapted to pump wash liquor in combination with the multiplicity of solid particles from the sump 250 to the drum 260.

The cleaning apparatus 200 can thus comprise means to recirculate the wash liquor and the multiplicity of solid particles. The solid particles can be recirculated from the lower portion of the housing 280B to the upper portion of the housing 280A. Recirculation of the solid particles enables their re-use in the treatment and/or cleaning operations. The solid particles can be recirculated along a path between the sump 250 and the drum 260. To facilitate transport of said solid particulate material along said recirculation path, the cleaning apparatus 200 can comprise ducting 240 extending from a lower portion of the housing 280B. The pumping means 252 can be adapted to pump said solid particles and wash liquor along said recirculation path via the ducting 240.

Furthermore, the cleaning apparatus 200 can comprise separating means 290 for separating said solid particles from the liquid medium (i.e. wash liquor) and control means 292, adapted to control entry of said solid particles into the drum 260. An example of suitable separating means 290 can include a filter material such as wire mesh located in a receptor vessel above said drum 260, and said control means 292 can comprise a valve located in feeder means, preferably in the form of a feed tube 294 attached to said receptor vessel, and connected to the interior of the drum 260. The separating means 290 enables excess liquid to be drained from the solid particles before they enter the drum 260. Other arrangements to enable the separation of liquid from the solid particles and to facilitate their entry into the drum 260 are also permissible however, and the invention is not limited in this regard.

In addition, the cleaning apparatus 200 can include a further recirculation means in the form of a liquid return pipe 298, allowing for the return of liquid separated by said separating means 290 to said sump 250, thereby facilitating re-use of said liquid in an environmentally beneficial manner.

Typically, the sump 250 comprises said multiplicity of solid particles prior to first use of the cleaning apparatus 200. In operation, water can be added to the solid particles in the sump 250. When a threshold or desired volume of water is present in the sump 250, the water and solid particles can be pumped into the drum 260. During the wash cycle, water and/or one or more cleaning agents can be added from the delivery means 212 into the drum 260 and ultimately any fluids can be transferred (e.g. via perforations in the walls of the drum) to the sump 250. Thus, during the course of the wash cycle, the contents of the sump 250 can comprise water in combination with one or more cleaning agents and the solid particles.

The cleaning apparatus 200 according to the invention is especially useful for the cleaning of substrates comprising a textile material, in particular one or more garments, linens, napery, towels or the like. The cleaning apparatus of the invention has been shown to be particularly successful in achieving efficient cleaning of textile fibres which may, for example, comprise either natural fibres, such as cotton, wool, silk or man-made and synthetic textile fibres, for example nylon 6,6, polyester, cellulose acetate, or fibre blends thereof. In addition, the cleaning apparatus can also be used to clean animal substrates such as animal skins, pelts or hides. Of these cattle and especially cow hides, leather and leather intermediates can be cleaned successfully by the present apparatus.

The polymeric particles or non-polymeric particles can be of such a shape and size as to allow for good flowability and intimate contact with the substrate. A variety of shapes of particles can be used, such as cylindrical, spherical or cuboid; appropriate cross-sectional shapes can be employed including, for example, annular ring, dog-bone and circular. In some embodiments, the particles can comprise generally cylindrical or spherical beads.

The polymeric particles or non-polymeric particles can have smooth or irregular surface structures and can be of solid, porous or hollow structure or construction.

Solid particles having one or more rough surfaces or irregular surface structures are particularly useful.

Preferably, the solid particles have an average mass of from about 1 mg to about 1000 mg, preferably from about 1 mg to about 700 mg, preferably from about 1 mg to about 500 mg, preferably from about 1 mg to about 300 mg, preferably from about 1 mg to about 150 mg, preferably from about 1 mg to about 70 mg, or from about 1 mg to about 50 mg, or from about 1 mg to about 35 mg, or from about 10 mg to about 30 mg, or from about 12 mg to about 25 mg, or from about 10 mg to about 800 mg, or from about 50 mg to about 700 mg, or from about 70 mg to about 600 mg.

Preferably, the solid particles have a surface area of from about 10 mm² to about 200 mm², preferably from about 10 mm² to about 120 mm², preferably from about 15 mm² to about 60 mm², preferably from about 20 mm² to about 40 mm², preferably from about 35 mm² to about 70 mm².

Preferably, the polymeric particles have an average density in the range of from about 0.5 to about 2.5 g/cm³; or from about 0.55 to about 2.0 g/cm³; or from about 0.6 to about 1.9 g/cm³, or from about 1.0 g/cm³ to about 1.8 g/cm³, preferably from about 1.4 to about 1.7 g/cm³.

The non-polymeric particles typically have an average density greater than the polymeric particles. Thus, the non-polymeric particles preferably have an average density in the range of about 3.5 to about 12.0 g/cm³; or from about 5.0 to about 10.0 g/cm³; or from about 6.0 to about 9.0 g/cm³.

Preferably, the average volume of the solid particles is in the range of from about 5 to about 500 mm³, preferably from about 5 to about 275 mm³, preferably from about 8 to about 140 mm³, or preferably from about 10 to about 120 mm³.

The polymeric or non-polymeric particles are typically substantially ellipsoidal, substantially cylindrical or substantially spherical in shape.

The cylindrical particles may be of oval cross section and in such embodiments, the major cross section axis length, a, can be in the range of from 2.0 to 6.0 mm, or from 2.2 to 5.0 mm or from 2.4 mm to 4.5 mm. The minor cross section axis length, b, can be in the range of from 1.3 to 5.0 mm or from 1.5 to 4.0 mm or from 1.7 mm to 3.5 mm. For an oval cross section, a>b. Preferably, the length of the cylindrical particles, h, is in the range of from about 1.5 mm to about 6 mm or from about 1.7 mm to about 5.0 mm or from about 2.0 mm to about 4.5 mm. The ratio h/b is typically in the range of from 0.5-10.

Alternatively, the cylindrical particles may be of circular cross section. The typical cross section diameter, d_{c}, can be in the region of from 1.3 to 6.0 mm or from 1.5 to 5.0 mm or from 1.7 mm to 4.5 mm. Preferably, the length of such particles, h_{c}, is in the range of from about 1.5 mm to about 6 mm, or from about 1.7 mm to about 5.0 mm, or from about 2.0 mm to about 4.5 mm. The ratio h_{c}/d_{c} is typically be in the range of from 0.5-10.

The particles may be generally spherical in shape (but not a perfect sphere) having a particle diameter, dₛ, in the range of from 2.0 to 8.0 mm or from 2.2 to 5.5 mm or from about 2.4 mm to about 5.0 mm.

The particles can be perfectly spherical in shape having a particle diameter, dₚₛ, in the range of from 2.0 to 8.0 mm, or from 3.0 to 7.0 mm or from about 4.0 mm to about 6.5 mm.

The particles preferably have a mean average largest linear size of from 1 to 100 mm, more preferably from 1 to 75 mm, more preferably from 1 to 50 mm, even more preferably from 1 to 25 mm, especially from 1 to 15 mm, more especially from 1 to 10 mm, and most especially from 2 to 8 mm. The average largest linear size is preferably measured using Vernier callipers. The average is preferably a number average, preferably of at least 10, 20, 30 or even 100 particles.

Preferably, the polymeric particles comprise polyalkenes such as polyethylene and polypropylene, polyamides, polyesters, polysiloxanes or polyurethanes or copolymers thereof, or the polymeric particles may comprise polyamides, polyesters, polysiloxanes or polyurethanes or copolymers thereof. Said polymers can be linear, branched or crosslinked. Preferably, said polymeric particles comprise polyamide or polyester particles, particularly particles of nylon, polyethylene terephthalate or polybutylene terephthalate. Preferably, said polymeric particles comprise polyamide particles. Said polyamides and polyesters are found to be particularly effective for aqueous stain/soil removal, whilst polyalkenes are especially useful for the removal of oil-based stains.

Polymeric particles comprising one or more polar polymers have been found to be particularly effective. Without wishing to be bound by theory, polymeric particles comprising one or more polar polymers are believed to facilitate an improved interaction with ozone bubbles enhancing the treatment of the substrate. Thus, polymeric particles selected from the group consisting of polyamides, polyesters, polysiloxanes and polyurethanes are advantageous.

Various nylon homo- or co-polymers can be used including, but not limited to, Nylon 6 and Nylon 6,6. The nylon can comprise Nylon 6,6 copolymer having a molecular weight in the region of from about 5000 to about 30000 Daltons, or from about 10000 to about 20000 Daltons, or from about 15000 to about 16000 Daltons. Useful polyesters can have a molecular weight corresponding to an intrinsic viscosity measurement in the range of from about 0.3 to about 1.5 dl/g, as measured by a solution technique such as ASTM D-4603.

The polymeric particles can comprise foamed polymers or unfoamed polymers.

Optionally, copolymers of the above polymeric materials may be employed for the purposes of the invention. Specifically, the properties of the polymeric materials can be tailored to specific requirements by the inclusion of monomeric units which confer particular properties on the copolymer. Thus, the copolymers can be adapted to attract particular staining materials by including monomer units in the polymer chain which, inter alia, are ionically charged, or include polar moieties or unsaturated organic groups. Examples of such groups can include, for example, acid or amino groups, or salts thereof, or pendant alkenyl groups.

The non-polymeric particles can comprise particles of glass, silica, stone, or any of a variety of metals or ceramic materials. Suitable metals include, but are not limited to, zinc, titanium, chromium, manganese, iron, cobalt, nickel, copper, tungsten, aluminium, tin and lead, and alloys thereof. Suitable ceramics include, but are not limited to, alumina, zirconia, tungsten carbide, silicon carbide and silicon nitride.

The present invention provides a method of treating one or more substrates, the method comprising agitating said one or more substrates in a treatment formulation comprising a multiplicity of solid particles, a liquid medium and bubbles of ozone. The method can be carried out using an apparatus as herein described. The method of treating said one or more substrates preferably is or comprises cleaning said one or more substrates.

In order to provide additional lubrication to the cleaning apparatus and thereby improve the transport properties within the system, wash liquor, which can be water, can be added to the substrates. Thus, more efficient transfer of the cleaning material to the substrate can be facilitated, and removal of soiling and stains from the substrate occurs more readily. The multiplicity of solid particles can thus elicit a cleaning effect on the substrate and water can simply aid the transport of said multiplicity of solid particles. Optionally, the substrates may be moistened by wetting with mains or tap water prior to loading into the cleaning apparatus. Wetting of the substrates within the cleaning apparatus is preferable. In any event, water can be added to the drum 260 such that the treatment is carried out so as to achieve a wash water or wash liquor to substrate ratio in the drum 260 which, is preferably from about 5:1 to about 0.1:1 w/w, more typically from about 2.5:1 to about 0.1:1 w/w, more typically from about 2.0:1 to about 0.8:1. By means of example, particularly favourable results have been achieved at ratios such as 1.75:1, 1.5:1, 1.2:1 and 1.1:1. Most conveniently, the required amount of water can be introduced into the drum 260 of the apparatus after loading of the substrates into said drum.

Whilst the method of the invention envisages the cleaning of the substrates by the treatment of a moistened substrate with only a multiplicity of solid particles, a liquid medium and ozone bubbles (i.e. in the absence of any further additives) optionally the formulation employed can additionally comprise at least one cleaning agent. The at least one cleaning agent can include at least one detergent composition. Said at least one cleaning agent can be introduced into the drum of the cleaning apparatus before or following commencement of the wash cycle. Said solid particles can be coated with said at least one cleaning agent.

The principal components of the detergent composition can comprise cleaning components and post-treatment components. The cleaning components can comprise surfactants, enzymes and bleach, whilst the post-treatment components can include, for example, anti-redeposition additives, perfumes and optical brighteners. It was found that the presence of the particles helps to assist the enzymes from becoming attacked or damaged by ozone. Thus, stains which respond to enzymes are removed more effectively by the present invention when using particles and treatment formulations comprising at least one enzyme. Particularly good stain removal results are obtained when the enzymes comprise amylase and/or lipase. Accordingly, the present apparatus and method are particularly suited to removing stains such as curry, starch, vegetable fat, milk fat, blood, egg and cocoa.

The formulations for use in the invention can further optionally include one or more other additives such as, for example builders, chelating agents, dye transfer inhibiting agents, dispersants, enzyme stabilizers, bleach activators, polymeric dispersing agents, clay soil removal agents, suds suppressors, dyes, structure elasticizing agents, fabric softeners, starches, carriers, hydrotropes, processing aids and/or pigments.

Examples of suitable surfactants that can be included in the detergent composition can be selected from non-ionic and/or anionic and/or cationic surfactants and/or ampholytic and/or zwitterionic and/or semi-polar nonionic surfactants. The surfactants are typically be present at a level of from about 0.1%, from about 1%, or even from about 5% by weight of the cleaning compositions to about 99.9%, to about 80%, to about 35%, or even to about 30% by weight of the cleaning compositions.

The inclusion of surfactants may assist in keeping ozone bubbles below the liquid surface and thereby facilitate their maintenance and longevity during the treatment cycle. The liquid medium in which the ozone bubbles are generated preferably therefore comprises at least one surfactant. The surfactant is preferably present in the liquid medium at from 0.01 to 10 wt %, more preferably from 0.1 to 5 wt %. The surfactant can be non-ionic, cationic or anionic or a mixture thereof. A mixture of non-ionic and anionic surfactants is especially preferred. Advantageously, the liquid medium comprises an antifoaming agent. The antifoaming agent can be a fluorine-containing antifoaming agent or more preferably a silicone antifoaming agent. The antifoaming agent is typically present at from 0.001 to 5 wt %, especially from 0.001 to 2 wt % and most especially from 0.001 to 1 wt % based on the liquid medium. By using both a surfactant and an antifoaming agent it is possible to stabilise ozone bubbles whilst not getting too much foaming. It can also be advantageous that the liquid medium includes an organic solvent. Suitable organic solvents for assisting in bubble formation include alcohols, glycols and ethers thereof. The organic solvent may be present in the liquid medium at from 0.1 to 10 wt %, or from 0.1 to 5 wt % or from 0.1 to 2 wt % relative to the liquid medium. Alternatively, the liquid medium comprises no organic solvents.

The detergent composition can include one or more detergent enzymes which provide cleaning performance and/or fabric care benefits. Examples of suitable enzymes include, but are not limited to, hemicellulases, peroxidases, proteases, other cellulases, other xylanases, lipases, phospholipases, esterases, cutinases, pectinases, keratanases, reductases, oxidases, phenoloxidases, lipoxygenases, ligninases, pullulanases, tannases, pentosanases, malanases, [beta]-glucanases, arabinosidases, hyaluronidase, chondroitinase, laccase, and amylases, or mixtures thereof. A typical combination can comprise a mixture of enzymes such as protease, lipase, cutinase and/or cellulase in conjunction with amylase.

Optionally, enzyme stabilisers can also be included amongst the cleaning components. In this regard, enzymes for use in detergents may be stabilised by various techniques, for example by the incorporation of water-soluble sources of calcium and/or magnesium ions in the compositions.

The detergent composition can include one or more bleach compounds and associated activators. Examples of such bleach compounds include, but are not limited to, peroxygen compounds, including hydrogen peroxide, inorganic peroxy salts, such as perborate, percarbonate, perphosphate, persilicate, and mono persulphate salts (e.g. sodium perborate tetrahydrate and sodium percarbonate), and organic peroxy acids such as peracetic acid, monoperoxyphthalic acid, diperoxydodecanedioic acid, N,N′-terephthaloyl-di(6-aminoperoxycaproic acid), N,N′-phthaloylaminoperoxycaproic acid and amidoperoxyacid. Bleach activators include, but are not limited to, carboxylic acid esters such as tetraacetylethylenediamine and sodium nonanoyloxybenzene sulphonate.

Suitable builders can be included as additives and include, but are not limited to, the alkali metal, ammonium and alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxybenzene-2,4,6-trisulphonic acid, and carboxymethyloxysuccinic acid, various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

The additives can also optionally contain one or more copper, iron and/or manganese chelating agents and/or one or more dye transfer inhibiting agents.

Suitable polymeric dye transfer inhibiting agents for use in the detergent composition include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

Optionally, the detergent composition can also contain dispersants. Suitable water-soluble organic materials are the homo- or co-polymeric acids or their salts, in which the polycarboxylic acid may comprise at least two carboxyl radicals separated from each other by not more than two carbon atoms.

Said anti-redeposition additives that can be included in the detergent composition are physico-chemical in their action and include, for example, materials such as polyethylene glycol, polyacrylates and carboxy methyl cellulose.

Optionally, the detergent composition can also contain perfumes. Suitable perfumes are generally multi-component organic chemical formulations which can contain alcohols, ketones, aldehydes, esters, ethers and nitrile alkenes, and mixtures thereof. Commercially available compounds offering sufficient substantivity to provide residual fragrance include Galaxolide (1,3,4,6,7,8-hexahydro-4,6,6,7,8,8-hexamethylcyclopenta(g)-2-benzopyran), Lyral (3- and 4-(4-hydroxy-4-methyl-pentyl) cyclohexene-1-carboxaldehyde and Ambroxan ((3aR,5aS,9aS,9bR)-3a,6,6,9a-tetramethyl-2,4,5,5a,7,8,9,9b-octahydro-1H-benzo[e][1] benzofuran). One example of a commercially available fully formulated perfume is Amour Japonais supplied by Symrise® AG.

Suitable optical brighteners that can be used in the detergent composition fall into several organic chemical classes, of which the most popular are stilbene derivatives, whilst other suitable classes include benzoxazoles, benzimidazoles, 1,3-diphenyl-2-pyrazolines, coumarins, 1,3,5-triazin-2-yls and naphthalimides. Examples of such compounds include, but are not limited to, 4,4′-bis[[6-anilino-4(methylamino)-1,3,5-triazin-2-yl]amino]stilbene-2,2′-disulphonic acid, 4,4′-bis[[6-anilino-4-[(2-hydroxyethyl)methylamino]-1,3,5-triazin-2-yl]amino]stilbene-2,2′-disulphonic acid, disodium salt, 4,4′-Bis[[2-anilino-4-[bis(2-hydroxyethyl)amino]-1,3,5-triazin-6-yl]amino]stilbene-2,2′-disulphonic acid, disodium salt, 4,4′-bis[(4,6-dianilino-1,3,5-triazin-2-yl)amino]stilbene-2,2′-disulphonic acid, disodium salt, 7-diethylamino-4-methylcoumarin, 4,4′-Bis[(2-anilino-4-morpholino-1,3,5-triazin-6-yl)amino]-2,2′-stilbenedisulphonic acid, disodium salt, and 2,5-bis(benzoxazol-2-yl)thiophene.

Said above components can be used either alone or in a desired combination and can be added at appropriate stages during the treatment cycle in order to maximise their effects.

Wherein said one or more substrates are keratinous substrates such as wool or woollen garments, the treatment can comprise applying a shrink resist treatment. A preferred shrink resist treatment comprises adding permonosulphuric acid to the liquid medium.

Preferably, the ratio of said solid particles to substrate is in the range of from about 0.1:1 to about 30:1 w/w, more typically from about 0.1:1 to about 20:1 w/w, more typically from about 0.1:1 to about 15:1 w/w, or from about 0.1:1 to about 10:1 w/w, or from about 0.5:1 to about 5:1 w/w, or from about 1:1 to about 3:1 w/w, for instance around 2:1 w/w. Thus, for example, for the cleaning of 5 g of fabric, 10 g of polymeric or non-polymeric particles may be employed in the invention.

The ratio of solid particulate material to substrate is suitably maintained at a substantially constant level throughout the treatment cycle. Consequently, pumping of fresh and recycled or recirculated solid particles can proceed at a rate sufficient to maintain approximately the same level of said solid particles in the drum 260 throughout the treatment operation, and to thereby ensure that the ratio of solid particles to substrate stays substantially constant until the treatment cycle has been completed.

The apparatus and the method of the present invention can be used for either small or large scale batchwise processes and finds application in both domestic and industrial cleaning processes. The present invention can be applied to domestic washing machines and processes.

In a typical wash cycle using the cleaning apparatus 200 of the invention, soiled substrates are first placed into the drum 260. Then, an appropriate amount of wash liquor (water, together with any additional cleaning agent) can be added to said drum 260 via the delivery means 212. Water can be pre-mixed with the cleaning agent prior to its introduction into the drum 260. Typically, water is added first in order to suitably wet or moisten the substrate before further introducing any cleaning agent. Optionally the water and the cleaning agent can be heated. Following the introduction of water and any optional cleaning agents (e.g. a detergent composition), the wash cycle can commence by rotation of the drum 260. The multiplicity of solid particles and (further) wash liquor residing in the sump 250, which optionally can be heated to a desired temperature, is then pumped upwardly via ducting 240 and to the separating means 290. After excess liquid has been drained, the solid particles enter the drum 260 via the feed tube 294.

During the course of agitation by rotation of the drum 260, water including any cleaning agents falls through the perforations in the drum 260 and into the sump 250. A quantity of the solid particles can also fall through perforations in the drum 260 and into the sump 250. Lifters disposed on the inner circumferential surface of the drum 260 can collect the solid particles as the drum 260 rotates and transfer the particles to the sump 250. On transfer to the sump 250, the pumping means 252 again pumps wash liquor in combination with the solid particles upwardly via ducting 240 to the separating means 290 and into the drum 260 through the feed tube 294. Consequently, additional solid particulate material can be entered into the drum 260 during the wash cycle. Furthermore, solid particles used in the cleaning operation and returned to the sump 250 can be reintroduced into the drum 260 and can therefore be re-used in either a single wash cycle or subsequent wash cycles. Wash liquor pumped upwardly from the sump 250 with the solid particles and which does not enter the drum 260 can be returned to the sump 250 via water return pipe 298.

Throughout the sequence of steps outlined in the wash cycle above, ozone bubbles can be generated in the wash liquor for use in the cleaning process utilizing the aforementioned plasma generator/bubble generator. Ozone bubbles can be generated in the wash liquor contained in sump 250 with the solid particles before the solid particles are introduced to the drum 260. Treatment of the solid particles with ozone before their introduction to drum 260 advantageously enhances the observed cleaning effect elicited on the substrates.

Ozone bubbles can be generated in wash liquor contained in the drum 260 immediately prior to and/or during the wash cycle. Treatment of the substrates by agitation with liquid containing ozone bubbles per se can enhance the cleaning effect compared to a conventional washing treatment. However, the inclusion of said multiplicity of solid particles in conjunction with wash liquor and bubbles of ozone according to the present invention provides a significantly enhanced cleaning effect.

The cleaning apparatus 200 can perform a wash cycle in a similar manner to a standard washing machine with the drum 260 rotating at between 30 and 40 rpm for several revolutions in one direction, then rotating a similar number of rotations in the opposite direction. This sequence can be repeated for up to about 60 minutes. During this period, multiplicity of solid particles can be introduced and reintroduced to the drum 260 from the sump 250 in the manner as described above.

As previously noted, the apparatus and method of the invention find particular application in the cleaning of textile fibres. Moreover, the conditions employed in such a cleaning system allow the use of significantly reduced temperatures from those which typically apply to the conventional wet cleaning of textile fabrics and, as a consequence, offer significant environmental and economic benefits. Thus, typical procedures and conditions for the wash cycle require that fabrics are generally treated according to the method of the invention at, for example, temperatures of from about 5 to about 95° C. for a duration of from about 5 to about 120 minutes in a substantially sealed system. Thereafter, additional time may be required for the completion of the rinsing and any further stages of the overall process, so that the total duration of the entire cycle is typically in the region of about 1 hour. The operating temperatures for the method of the invention is preferably in the range of from about 10 to about 60° C. or from about 15 to about 40° C.

Preferably, the solid particles are re-used at least once in a subsequent treatment cycle according to the method of treating substrate(s) disclosed herein. The solid particles may be reused one or more times, preferably greater than once, and preferably used for at least 5, 10, 50, 100, 200, 300, 400 and 500 treatment cycles. A treatment cycle comprises the treating of substrate(s) with the solid particles and further comprises the separation of the particles from the substrate(s), and optionally further comprises one or more of the rinse, spin and drying step(s) conventional in this art.

The method of the invention can further include the step of subjecting the solid particles to a cleaning procedure after the treatment of the substrate(s) with said solid particles. When the solid particles are reused it may be desirable to intermittently clean the particles. This can be helpful in preventing unwanted contaminants from building up and/or in preventing treatment components from degrading and then depositing on the one or more substrates. A particle cleaning step can be performed after every 10, after every 5, after every 3, after every 2 or after every 1 agitation step(s), and preferably this means after every 10, after every 5, after every 3, after every 2 or after every 1 treatment cycles. The particle cleaning step can comprise washing the solid particles with a cleaning formulation. The cleaning formulation can be a liquid medium such as water, an organic solvent or a mixture thereof. The cleaning formulation can comprise at least 10 wt %, more preferably at least 30 wt %, even more preferably at least 50 wt %, especially at least 80 wt % water, more especially at least 90 wt % water. The cleaning formulation can comprise one or more cleaning agents to aid the removal of any contaminants. Suitable cleaning agents can include surfactants, detergents, dye transfer agents, biocides, fungicides, builders and metal chelating agents. The particles can be cleaned at a temperature of from 0° C. to 40° C. for energy economy but for even better cleaning performance temperatures of from 41 to 100° C. can be used. The cleaning times can generally be from 1 second to 10 hours, typically from 10 seconds to 1 hour and more typically from 30 seconds to 30 minutes. The cleaning formulation can be acidic, neutral or basic depending on the pH which best provides for cleaning of the specific treatment formulation components. During cleaning it can be desirable that the polymeric or non-polymeric particles are agitated so as to speed up the cleaning process. The cleaning step for the solid particles can be performed in the absence of any other substrate. The method of the invention can be performed in an apparatus fitted with an electronic controller unit which is programmed to cause the apparatus to perform the agitation step (cycle) and then intermittently the particle cleaning step (cycle). When a different treatment formulation is used and/or a different substrate it can be desirable to perform the particle cleaning step so as to prevent or reduce the potential for any cross contamination of chemicals or materials.

The solid particles can be recovered from the treatment chamber after the treatment of the one or more substrates.

Treatment formulations comprising bubbles of ozone can be utilised in a method of inhibiting the accumulation of bacteria and/or sterilising one or more internal components of washing machine. The method can comprise circulating a formulation comprising a liquid medium and bubbles of ozone within the interior of said washing machine, preferably wherein the bubbles have an average diameter of no more than 10 mm. The inclusion of said multiplicity of solid particles in the formulation can serve to further inhibit the build-up of bacteria.

As noted above, the one or more substrates for treatment by the apparatus of the invention can be paper or cardboard or the like. Thus, in such embodiments, the apparatus described herein can be can be used in a paper or cardboard recycling process. Particularly, the apparatus can be used in a de-inking process. A standard apparatus for performing such paper recycling and/or de-inking operations, typically which comprises a treatment chamber in the form of a rotatably mounted drum, are well known to those in art and can be modified to include the features of the plasma generator and/or bubble generator as described herein. Furthermore, said apparatus can further include said multiplicity of solid particles as an effective means of conferring mechanical action on the paper or cardboard substrate. Typically, in such embodiments the treatment conducted can be effective to modify or transform the properties of the substrate. In the case of de-inking, said treatment can be effective to bleach and/or oxidise the substrate. De-inking and paper recycling is, in effect, a cleaning wherein the substrate is or comprises paper.

Also as noted above, the apparatus of the invention can be a dishwasher. Substrates to be treated can therefore comprise culinary articles such as dishware, plates, tableware, glassware, cutlery and the like. The dishwasher can be modified to include the features of the plasma generator and/or bubble generator as described herein.

The invention will now be further illustrated, though without in any way limiting the scope thereof, by reference to the following examples and associated illustrations.

### Examples

In the present invention, the average diameter of the bubbles is conveniently measured by image analysis using conventional techniques well known in the art. Preferably, however, the average diameter of the bubbles is measured by acoustic bubble spectroscopy.

A suitable acoustic bubble spectrometer is sold by Dynaflow as an Acoustic Bubble Spectrometer (ABS). An ABS apparatus and method is described in the publication “Development of an acoustic instrument for bubble size distribution measurement”; Science Direct; Journal of Hydrodynamics 2010, 22(5), supplement: 330-336; 9^{th} International Conference on hydrodynamics Oct. 11-15, 2010. Preferably, the Acoustic Bubble Spectrometer comprises one or more hydrophones which are typically in pairs, more preferably from 1 to 20 pairs of hydrophones and especially preferably 2, 3, 4, 5, 6, 7, 8, 9 and 10 pairs of hydrophones. A particularly preferred arrangement uses 4 pairs of hydrophones. Each pair of hydrophones preferably comprises a transmitter hydrophone and a receiver hydrophone. The transmitter and receiver hydrophones typically face each other and are separated by and submerged in the liquid medium in which the bubbles are present. Preferably, each transmitter hydrophone generates a different frequency. The frequency is preferably 1 KHz or more, more preferably from 1 KHz to 1000 KHz and especially from 10 KHz to 700 KHz. The frequencies are preferably substantially monochromatic. Frequencies of 28 KHz, 50 KHz, 70 KHz, 100 KHz, 200 KHz, 250 KHz and 500 KHz are especially preferred. The data from receiver hydrophone(s) is preferably amplified, stored and mathematically transformed using an inverse problem solution, especially when using a constrained optimisation method as described in (i) R. Duraiswami, S. Prabhukumar & G. L. Chahine, “Bubble counting using an inverse acoustic scattering method,” J. Acoust. Soc. Am., 104, 2699-2717, 1998; (ii) R. Duraiswami and G. L. Chahine, “Bubble density measurement using an inverse acoustic scattering technique,” NSF SBIR Phase I project report, also Dynaflow Technical Report 92004-1, 1992. (iii) S. Prabhukumar, R. Duraiswami, & G. L. Chahine, “Bubble size measurement using inverse acoustic scattering: Theory & Experiments,” ASME Cavitation & Multiphase Flow Forum, 1996 (iv) R. Duraiswami, S. Pabhukumar & G. L. Chahine, “Development of an Acoustic Bubble Spectrometer (ABS) Using an Acoustic Scattering Technique,” DYNAFLOW, INC. Technical Report 94001-1, July 1996. Preferably, the hydrophones are located above the bubble generator or the hydrophones are located in a flow cell through which liquid medium containing the bubbles is pumped.

It will be appreciated that the average bubble diameter is the average diameter of the bubbles in the liquid medium. A blank or bubble-free measurement of the liquid medium is typically performed for calibration purposes.

Preferably, the average diameter is measured as the equivalent spherical diameter of the bubble.

Preferably the average diameter is taken from at least 100 and more preferably at least 1000 bubbles.

Preferably, the average diameter measurement is performed at 1 atmosphere of pressure. Preferably the average diameter measurement is performed at 20° C.

Preferably, the liquid medium for measuring the bubble diameter is or comprises water. The liquid medium typically comprises a surfactant which is typically present at from 0.1 to 10 wt % based on the liquid medium.

### Example 1—General Detergency and Bleaching/Cleaning Performance

Nylon 6,6 beads (2.0 kg of Solvay Technyl XA1493) were added to a continuously stirred reaction vessel containing 26 litres of water. The reaction vessel was fitted with a plasma micro-reactor at the base, which was equipped with a standard power unit, high voltage probe (ADC-212, Pico Technology Limited) and a standard current meter (UNI-T, UT201). Power was applied to the plasma micro-reactor (typically 14-17 mA) and an air flow of 60-80 litres/minute applied. The electrode spacing was no more than 10 mm. Ozone production was monitored using a standard technique (Hoigne, J. and Bader, H., 1981, Colourimetric Method For The Measurement Of Aqueous Ozone Based On The Decolourization Of Indigo Derivatives, in Ozonization Manual For Water And Wastewater Treatment, W. J. Masschelein (editor), John Wiley And Sons Inc., New York). In subsequent experiments a power usage of 17 mA and air flow of 80 litres/minute were generally applied. The average bubble diameter was in the range of from 0.01 to 1 mm.

The apparatus was then used to assess the cleaning performance on stained substrates. A WFK stain monitor (PCMS-55_05-05x05) was used to assess cleaning performance. In order to ensure intimate contact with the Nylon 6,6 beads and the treatment water, each required WFK stain was cut out from the stain monitor and labelled. The stain patches were immersed in the reaction vessel in continuous agitation when the power and air flow commenced, and were retained in the reaction vessel during the period of the experiment. At the end of the experiment, the power and air flow were switched off and the WFK patches rinsed with distilled water and allowed to air dry. In this experiment, the ozone plasma is applied during the wash only. A number of control experiments were run (i.e. Runs 1, 2 and 4). The first control experiment (Run 1) involved subjecting the WFK patches to airflow from the plasma micro reactor only for 10 minutes—no power was applied to the plasma micro-reactor and hence no ozone was produced, and no Nylon 6,6 beads were used. The second control experiment (Run 2) involved only the use of beads in a 10 minute treatment cycle—no air flow or power was applied to the plasma micro reactor and hence no ozone was applied to the substrate. In the third experiment (Run 3), a combination of Nylon 6,6 beads were used and an airflow of 80 litres/minute and power of 17 mA applied to the plasma micro reactor to produce ozone for 10 minutes. In the fourth (control) experiment (Run 4) no Nylon 6,6 beads were used but an airflow of 80 litres/minute and power of 17 mA applied to the plasma micro reactor to produce ozone for 10 minutes. The results from Runs 1-4 are shown In Table 1.

Measurements of the CIE L*, a* and b* colour parameters were made for each stain type on these WFK stain patches, using a Konica-Minolta CM-3600A spectrophotometer (UV component included, 8° aperture). The bleachable stains tested were:
Red wine on Cotton, aged (IEC456);
Curry on Cotton;
Blood on Cotton, aged (IEC456); and
Pigment/Vegetable Fat/Milk on Cotton.

The dE colour changes were then calculated for these stains versus their equivalents on unwashed stain monitors used as controls (higher values of dE reflecting better cleaning performance). These dE values were then averaged across all of these stains to give an overall measure of bleaching performance. It should be noted that these stains will only effectively be cleaned when bleaching chemistry is active in the cleaning formulation.

TABLE 1
DETERGENCY & BLEACHING EFFECT FROM PLASMA TREATED
NYLON BEADS - 10 MINUTE PLASMA TREATMENT

| | All | General | Bleachable | Amylase | Protease |
|---|---|---|---|---|---|
| | Stains | Detergency | Stains | Stains | Stains |
| Sample | (dE) | (dE) | (dE) | (dE) | (dE) |
| Run 1. Air | 9.03 | 5.53 | 16.92 | 2.13 | 20.13 |
| Only | | | | | |
| Treatment | | | | | |
| Run 2. | 10.72 | 7.05 | 17.34 | 4.35 | 22.01 |
| Beads | | | | | |
| Only | | | | | |
| Treatment | | | | | |
| Run 3. | 11.27 | 7.91 | 18.84 | 5.35 | 24.63 |
| Beads | | | | | |
| Plus 10 | | | | | |
| Minute | | | | | |
| Plasma | | | | | |
| Treatment | | | | | |
| Run 4. 10 | 9.36 | 5.54 | 17.96 | 2.70 | 21.90 |
| Minute | | | | | |
| Plasma | | | | | |
| Treatment | | | | | |
| (No Beads) | | | | | |

As can be seen from Table 1, the general detergency and bleaching performance of the Nylon 6,6 beads is significantly improved when used in combination with the ozone plasma micro-reactor treatment versus the bead, air and plasma only controls. Furthermore, this general detergency and bleaching effect remains superior to the controls (higher dE) without any added detergency in the system. It will further be appreciated that there is a surprising synergy between the bead-cleaning and plasma treatment in terms of cleaning performance. Thus, in respect of the dE (all stains) values in Table 1, and using the “air-only” treatment as the control run (dE=9.03), bead-cleaning combined with plasma treatment exhibited a cleaning performance (dE=11.27 and Δ(dE)=11.27-9.03=2.24) which shows an additive effect that is greater than the sum of “beads-only” (dE=10.72; and Δ(dE)=10.72-9.03=1.69) and “plasma only” (dE=9.36 and Δ(dE)=9.36-9.03=0.33). In other words, the beads and plasma treatment produce a synergistic effect.

Similarly, there is a synergistic effect shown for the general detergency: the Δ(dE) of 2.38 (i.e. 7.91−5.53) for the combined beads/ozone treatment is greater than the sum of the Δ(dE) for each of the individual treatments (Δ(dE) for beads only=7.05−5.53=1.52; and the Δ(dE) for ozone only −5.54−5.53=0.01), which is 1.53.

A similar synergistic effect is also shown for the bleachable stains: the Δ(dE) of 1.92 for the combined beads/ozone treatment is greater than the sum of the Δ(dE) for each of the individual treatments, which is 1.46.

A similar synergistic effect is also shown for the amylase stains: the Δ(dE) of 3.22 for the combined beads/ozone treatment is greater than the sum of the Δ(dE) for each of the individual treatments, which is 2.79.

A similar synergistic effect is also shown for the protease stains: the Δ(dE) of 4.5 for the combined beads/ozone treatment is greater than the sum of the Δ(dE) for each of the individual treatments, which is 3.65.

### Example 2: General Detergency and Bleaching/Cleaning Performance Using Nylon Beads In the Presence of Biological Detergent at High and Low Levels

Nylon 6,6 beads (2.0 kg of Solvay Technyl XA1493) were added to a continuously stirred reaction vessel containing 26 litres of water. The reaction vessel was fitted with a plasma micro-reactor at the base, which is equipped with a standard power unit, high voltage probe (ADC-212, Pico Technology Limited) and a standard current meter (UNI-T, UT201). To produce ozone, power was applied to the plasma micro-reactor (typically 17 mA) and an air flow of 80 litres/minute applied. In this case nylon beads were treated for 5 minutes in the presence of Xeros Pack 1 Biological Laundry Liquid at a high (5.0 g) and low level (1.0 g). The apparatus was then used to assess the cleaning performance on stained substrates. A WFK stain monitor (PCMS-55 05-05x05) was used to assess cleaning performance. In order to ensure intimate contact with the Nylon 6,6 beads and the treatment liquor, each required WFK stain was cut out from the stain monitor and labelled. The stain patches were immersed in the reaction vessel in continuous agitation when the power and air flow commenced, and were retained in the reaction vessel during the period of the experiment. At the end of the experiment, the power and air flow were switched off and the WFK patches rinsed with distilled water and allowed to air dry. In this experiment, the ozone plasma is applied during the wash only.

A number of control experiments were run (i.e. Runs 1, 2, 3 and 4). The first control experiment (Run 1) involved subjecting the WFK patches to airflow from the plasma micro reactor in the presence of detergent (low level, 1.0 g) for 5 minutes—no power was applied to the plasma micro-reactor and hence no ozone was produced, and no Nylon 6,6 beads were used. The second control experiment (Run 2) involved subjecting the WFK patches to airflow from the plasma micro reactor in the presence of detergent (high level, 5.0 g) for 5 minutes—no power was applied to the plasma micro-reactor and hence no ozone was produced. No Nylon 6,6 beads were used. The third control experiment (Run 3) involved subjecting the WFK patches to airflow from the plasma micro reactor in the presence of detergent (low level, 1.0 g) for 5 minutes with 17 mA applied to the plasma micro-reactor and hence ozone was produced, but no Nylon 6,6 beads were used. The fourth control experiment (Run 4) involved subjecting the WFK patches to airflow from the plasma micro reactor in the presence of detergent (high level, 5.0 g) for 5 minutes with 17 mA applied to the plasma micro-reactor and hence ozone was produced. No Nylon 6,6 beads were used. The fifth experiment (Run 5) involved subjecting the WFK patches to airflow from the plasma micro reactor in the presence of detergent (low level, 1.0 g) for 5 minutes with 17 mA applied to the plasma micro-reactor and hence ozone was produced. Nylon 6,6 beads (2.0 kg) were used. The sixth experiment (Run 6) involved subjecting the WFK patches to airflow from the plasma micro reactor in the presence of detergent (high level, 5.0 g) for 5 minutes with 17 mA applied to the plasma micro-reactor and hence ozone was produced. Nylon 6,6 beads (2.0 kg) were used. The results from Runs 1-6 are shown In Table 2.

TABLE 2
TREATMENT OF NYLON BEADS WITH OZONE
PLASMA AT TWO DETERGENT LEVELS.

| | | | Vegetable | Aged |
|---|---|---|---|---|
| | | Curry | Fat & Milk | Cocoa |
| | Amylase | stain | stain | stain |
| Sample | (dE) | (dE) | (dE) | (dE) |
| Run 1 | 2.60 | 3.28 | 4.06 | 2.53 |
| Detergent (low level) + Air; | | | | |
| 5 mins | | | | |
| Run 2 | 3.50 | 5.38 | 4.66 | 3.01 |
| Detergent (high level) + Air; | | | | |
| 5 mins | | | | |
| Run 3 | 2.34 | 3.29 | 2.72 | 4.21 |
| Ozone Plasma + detergent | | | | |
| (low level); 5 mins | | | | |
| Run 4 | 4.56 | 6.03 | 6.35 | 5.96 |
| Ozone Plasma + detergent | | | | |
| (high level); 5 mins | | | | |
| Run 5 | 4.28 | 5.64 | 4.61 | 5.78 |
| Beads + Ozone Plasma + | | | | |
| detergent (low level); 5 mins | | | | |
| Run 6 | 5.63 | 8.06 | 6.58 | 7.59 |
| Beads + Ozone Plasma + | | | | |
| detergent (high level); 5 mins | | | | |

The results in Table 2 show that, unexpectedly, the beads provide a protective effect for enzymes in the presence of ozone. Ozone, being an extremely powerful oxidising agent, was expected to degrade enzymes. Thus, in the absence of beads, the aggregate amylase stain showed a reduction in activity when low level detergent was used with ozone plasma treatment compared to the corresponding wash in the presence of air only (i.e. 2.34 dE compared to 2.60 dE). However, in the presence of beads, the use of ozone plasma treatment at a low level of detergent leads to an increase of the amylase cleaning performance to 4.28 dE. A similar protective effect is also seen for stain 6 (curry) and especially stain 12 (vegetable fat & milk). For stain 12, plasma treatment at a low level of detergent leads to a dramatic fall in lipase and amylase activity compared to the air-only control (i.e. cleaning performance falls to 2.72 dE with ozone compared to 4.06 with air). In the presence of beads, however, at a low detergent level, the cleaning performance was increased to 4.61 dE. The loss of activity with the use of ozone plasma treatment in the absence of beads was not seen for stain 13 (aged cocoa), which is susceptible to protease enzymes, but the combination of ozone plasma and beads provided significantly improved cleaning performance.

Thus, the results demonstrate that combination of beads and ozone plasma treatment provide a considerable enhancement in cleaning performance across a range of enzymatic stains (amylase, lipase and protease) compared to washes in the absence of beads. Unexpectedly, the results demonstrate that the beads have a protective effect on enzymatic activity in the case of amylase and lipase at low detergent levels in the presence of ozone plasma.

The presence of beads therefore allows a reduction in the amount of agent required to achieve the desired cleaning effect as well as offering enhancements in cleaning performance. Without being bound by theory, it is suggested that the beads are protecting the amylase and lipase enzymes in the biological detergent from degradation by attracting and retaining the micro-bubbles containing ozone on the bead surface due to polarity. Thus it can be demonstrated that the ozone cleaning agent is delivered directly to the substrate surface by means of controlled, localised application from the polymeric particles which aid in the transport of these cleaning agents.

### Example 3: Cleaning Performance Using Nylon Beads in the Presence of Biological Detergent: Comparison of Pre-Treated and Non Pre-Treated Nylon with Ozone Plasma

In the method of the invention, Nylon 6,6 beads (2.0 kg of Solvay Technyl XA1493) were added to a continuously stirred reaction vessel containing 26 litres of water. The reaction vessel was fitted with a plasma micro-reactor at the base, which is equipped with a standard power unit, high voltage probe (ADC-212, Pico Technology Limited) and a standard current meter (UNI-T, UT201). To produce ozone, power was applied to the plasma micro-reactor (typically 17 mA) and an air flow of 80 litres/minute applied. In this case the treatment cycles were for 15 minutes in the presence of Xeros Pack 1 Biological Laundry Liquid at a high (5.0 g) level. The apparatus was then used to assess the cleaning performance on stained substrates. A WFK stain monitor (PCMS-55_05-05x05) was used to assess cleaning performance. In order to ensure intimate contact with the Nylon 6,6 beads and the treatment liquor, each required WFK stain was cut out from the stain monitor and labelled. The stain patches were immersed in the reaction vessel in continuous agitation when the power and air flow commenced, and were retained in the reaction vessel during the period of the experiment. At the end of the experiment, the power and air flow were switched off and the WFK patches rinsed with distilled water and allowed to air dry. In this experiment, the ozone plasma is applied during the wash only, except for Run 5 which is discussed hereinbelow.

A number of control experiments were run (i.e. Runs 1, 2 and 3). The first control experiment (Run 1) involved subjecting the WFK patches to airflow from the plasma micro reactor in the presence of detergent (high level, 5.0 g) for 15 minutes—no power was applied to the plasma micro-reactor and hence no ozone was produced, and no Nylon 6,6 beads were used. The second control experiment (Run 2) involved subjecting the WFK patches to airflow from the plasma micro reactor in the presence of detergent (high level, 5.0 g) for 15 minutes—no power was applied to the plasma micro-reactor and hence no ozone was produced. Nylon 6,6 beads were used. The third control experiment (Run 3) involved subjecting the WFK patches to airflow from the plasma micro reactor in the presence of detergent (high level, 5.0 g) for 15 minutes with 17 mA applied to the plasma micro-reactor and hence ozone was produced. No Nylon 6,6 beads were used.

The fourth experiment (Run 4) involved subjecting the WFK patches to airflow from the plasma micro reactor in the presence of detergent (high level, 5.0 g) for 15 minutes with 17 mA applied to the plasma micro-reactor and hence ozone was produced. Nylon 6,6 beads were used in the treatment cycle but were not pre-treated with ozone. The fifth experiment (Run 5) involved pre-treating the Nylon 6,6 beads in 26 litres water with ozone for 15 minutes with the plasma micro-reactor using an air flow of 80 litres/minute with 17 mA applied. The wash liquor was then drained and a further 26 litres of water added. The WFK patches were then subjected to airflow at 80 litres/minute from the plasma micro-reactor in the presence of detergent (high level, 5.0 g) in the presence of ozone pre-treated Nylon 6,6 beads for 15 minutes with 17 mA applied to the plasma micro-reactor to produce ozone.

The results from Runs 1-5 are shown In Table 3.

TABLE 3
OVERVIEW OF CLEANING PERFORMANCE USING
NYLON BEADS AND OZONE PLASMA IN THE
PRESENCE OF DETERGENT. EFFECT OF PRE-
TREATMENT WITH OZONE PLASMA.

| | Amylase | Protease |
|---|---|---|
| Sample | (dE) | (dE) |
| Run 1 | 3.49 | 20.99 |
| Air + detergent (high level); 15 mins | | |
| Run 2 | 4.52 | 24.22 |
| Beads + Air + detergent (high level); 15 mins | | |
| Run 3 | 3.74 | 22.02 |
| Ozone Plasma + detergent (high level); 15 mins | | |
| Run 4 | 6.75 | 26.14 |
| Beads + Ozone Plasma + detergent (high level); | | |
| 15 mins | | |
| Run 5 | 7.00 | 25.85 |
| Pre-treatment of beads with ozone plasma for | | |
| 15 mins; then further treatment with ozone plasma | | |
| and detergent (high level) for 15 mins | | |

The results shown in Table 3 again demonstrate the beneficial cleaning performance of using beads in combination with ozone and detergent compared to the controls. In particular, the results in Table 3 demonstrate that there was a dramatic improvement in both protease and amylase enzymatic stain cleaning performance when beads and ozone plasma were combined, and that the combination of beads and ozone plasma produced an unexpected synergistic effect. Thus, for the protease stain, the cleaning performance of “beads+ozone plasma+detergent” (ΔdE=26.14-20.99=5.15) is significantly greater than the additive performance of “beads+detergent” (ΔdE=24.22-20.99=3.23) and “ozone+detergent” (ΔdE=22.02-20.99=1.03), using the “air+detergent” run as a control. The same synergistic effect is observed for the amylase stain.

The results in Table 3 also demonstrate that pre-treatment of the beads with ozone plasma followed by a wash with detergent and further ozone plasma further enhanced the cleaning performance for enzymatic stains.

Table 4 shows a further breakdown in cleaning performance for this example in respect of sebum, starch, and aged cocoa.

TABLE 4
EXAMPLES OF SPECIFIC STAIN CLEANING PERFORMANCE
USING NYLON BEADS AND OZONE PLASMA IN
THE PRESENCE OF DETERGENT.

| | | | Aged |
|---|---|---|---|
| | Sebum | Starch | Cocoa |
| Sample | (dE) | (dE) | (dE) |
| Run 1 | 1.91 | 1.10 | 2.85 |
| Air + detergent; 15 mins | | | |
| Run 2 | 3.43 | 3.15 | 7.32 |
| Beads + Air + detergent; 15 mins | | | |
| Run 3 | 2.54 | 1.23 | 3.91 |
| Ozone Plasma + detergent; 15 mins | | | |
| Run 4 | 4.81 | 7.00 | 12.82 |
| Beads + Ozone Plasma + detergent; 15 mins | | | |
| Run 5 | 5.57 | 9.12 | 11.75 |
| Pre-treatment of beads with ozone plasma for | | | |
| 15 mins; then further treatment with ozone | | | |
| plasma and detergent for 15 mins | | | |

The results in Table 4 show a dramatic improvement in cleaning performance for sebum, starch and aged cocoa stains when using a combination of beads and ozone. The data demonstrate that the combination of beads and ozone provides a synergistic effect. Thus, the improvement in dE value of each stain (relative to the “air and detergent” control) for the “beads and ozone” combination is greater than the sum of the dE values for each of beads and ozone when used individually, and this effect is observed across all three stains. When the use of ozone plasma is supplemented with pre-treatment of the beads, the effect is further enhanced. Without being bound by theory, the result suggests that pre-treatment with ozone plasma enhances the cleaning performance of the beads by forming or immobilising bleaching species on the bead surface.

The results confirm therefore that the beads allow a reduction in the amount of cleaning agent required to achieve the desired cleaning effect, as well as offering enhancements in cleaning performance. Without being bound by theory, the beads are believed to exert a protective effect on protease as well as the amylase and lipase enzymes in the biological detergent from degradation by a powerful oxidising agent, ozone.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. Apparatus for the treatment of one or more substrates comprising:
a treatment chamber configured to receive a liquid medium and one or more substrates;
a supply of a treatment gas comprising ozone; and
one or more conduits to convey said treatment gas to a bubble generator wherein said bubble generator is operable to form bubbles of said treatment gas in said liquid medium, wherein the apparatus comprises a multiplicity of solid particles.

2. Apparatus as claimed in claim 1 further comprising:
a gas source to provide a feed gas comprising oxygen;
a plasma generator comprising electrodes, having a space between them;
one or more delivery conduits to transport said feed gas from the gas source through the space between the electrodes;
a power source to apply a voltage across the electrodes to dissociate the oxygen to form said treatment gas comprising ozone.

3. Apparatus as claimed in claim 2 wherein the electrodes have a space between them of no more than 10 mm, preferably no more than 1 mm, and preferably at least 0.001 mm.

4. Apparatus as claimed in claim 2, wherein said apparatus employs a voltage from about 1 mV to about 10,000V, preferably from about 150 to about 450V.

5. Apparatus as claimed in claim 1, wherein said bubbles have an average diameter of no more than 10 mm, preferably no more than 1 mm.

6. Apparatus as claimed in claim 1 further comprising a fluidic oscillator operable to oscillate the flow of at least said treatment gas.

7. Apparatus as claimed in claim 6 wherein the oscillations effected by the fluidic oscillator are at a frequency from about 0.01 to about 1000 Hz.

8. Apparatus as claimed in claim 6 wherein the treatment gas is oscillated along said one or more conduits without oscillating the conduits, other than by any reaction of said conduits to the oscillation of the oscillating treatment gas.

9. Apparatus as claimed in claim 6 wherein the fluidic oscillator is arranged to oscillate the treatment gas and said oscillation is of the type that has less than 30% backflow of gas from an emerging bubble.

10. Apparatus as claimed in claim 6 in which the fluidic oscillator comprises an arrangement in which gas flow is oscillated between two paths, at least one of said paths providing a source for said treatment gas.

11. Apparatus as claimed in claim 10 wherein the fluidic oscillator comprises a fluidic diverter supplied with said treatment gas under constant pressure through a supply port that divides into respect output ports, and including means to oscillate flow from one output port to the other.

12. Apparatus as claimed in claim 1 wherein said bubble generator comprises one or more bubble diffuser(s), optionally wherein said bubble diffuser comprises a polymer membrane, porous ceramic membrane, a perforated metal or alloy membrane, a porous glass membrane, or a carbon or glass fibre or a metal or alloy wire mesh.

13. Apparatus as claimed in claim 12 wherein the bubble diffuser comprises a multiplicity of pores having an average diameter of no more than 10 mm, preferably no more than 1 mm, and especially no more than 0.1 mm, and preferably wherein said pores have an average diameter of at least 0.1, preferably at least 1, and preferably at least 10 microns.

14. Apparatus as claimed in claim 12 configured such that the pressure of the treatment gas in the bubble generator is at least 1.1 bar and no more than 10 bar, and such that the pressure of the treatment gas in the bubble generator is greater than the liquid medium in the treatment chamber of the apparatus.

15. Apparatus as claimed in claim 1 wherein the treatment chamber comprises a rotatably mounted drum.

16. Apparatus as claimed in claim 1 comprising access means moveable between an open position wherein said one or more substrates can be placed within the treatment chamber and a closed position wherein the apparatus is substantially sealed.

17. Apparatus as claimed in claim 1 comprising one or more delivery means to introduce said liquid medium into the treatment chamber.

18. Apparatus as claimed in claim 1 wherein said bubble generator is located in said treatment chamber.

19. Apparatus as claimed in claim 1 wherein said apparatus comprises said multiplicity of solid particles for agitation with said one or more substrates in said treatment chamber.

20. Apparatus as claimed in claim 1 wherein said apparatus comprises a storage compartment for said solid particles.

21. Apparatus as claimed in claim 20 wherein said storage compartment further comprises a liquid medium and wherein the or a bubble generator is located in said storage compartment.

22. Apparatus as claimed in claim 21 wherein the apparatus comprises a first bubble generator located in said storage compartment, a second bubble generator located in said treatment chamber and one or more conduits to convey said treatment gas to said first bubble generator and said second bubble generator and wherein said first bubble generator and said second bubble generator are operable to form bubbles in said liquid medium, said bubbles preferably having an average diameter of no more than 10 mm, preferably no more than 1 mm.

23. Apparatus as claimed in claim 20 wherein said apparatus comprises pumping means configured to pump said multiplicity of solid particles into the treatment chamber.

24. Apparatus as claimed in claim 20 wherein said apparatus is adapted to recirculate the solid particles along a recirculation path from the storage compartment to the treatment chamber.

25. Apparatus as claimed in claim 20 wherein the multiplicity of solid particles comprise or consist of a multiplicity of polymeric particles, or a multiplicity of non-polymeric particles, or a mixture of a multiplicity of polymeric and non-polymeric particles.

26. Apparatus as claimed in claim 20 wherein the multiplicity of solid particles comprise or consist of a multiplicity of polymeric particles.

27. Apparatus as claimed in claim 26 wherein the polymeric particles are selected from particles of polyalkenes, polyamides, polyesters, polysiloxanes, polyurethanes or copolymers thereof.

28. Apparatus as claimed in claim 25 wherein the polymeric particles comprise particles of one or more polar polymers.

29. Apparatus as claimed in claim 28 wherein the polymeric particles comprise particles of polyamide or polyester or copolymers thereof.

30. Apparatus as claimed in claim 29 wherein the polyamide particles comprise particles of nylon.

31. Apparatus as claimed in claim 25 wherein the non-polymeric particles comprise particles of glass, silica, stone, metals or ceramic materials.

32. Apparatus as claimed in claim 25 wherein the polymeric particles have an average density of from about 0.5 to about 2.5 g/cm³.

33. Apparatus as claimed in claim 25 wherein the non-polymeric particles have an average density of from about 3.5 to about 12.0 g/cm³.

34. Apparatus as claimed in claim 19 wherein the multiplicity of solid particles are in the form of beads.

35. Apparatus as claimed in claim 19 wherein the solid particles are reused for one or more treatment cycle(s), wherein a treatment cycle comprises the treating of said substrate(s) with said solid particles and further comprises the separation of the particles from the substrate(s), in, with or by said treatment apparatus.

36. Apparatus as claimed in claim 1 wherein the apparatus is a washing machine.

37. Apparatus as claimed in claim 1 wherein the apparatus is a dishwasher.

38. Apparatus as claimed in claim 1 wherein said one or more substrates are paper or cardboard and the like.

39. A washing machine for cleaning one or more substrates, said washing machine comprising: a housing containing a drum rotatably mounted therein wherein said drum is configured to receive wash liquor;
access means moveable between an open position wherein said one or more substrates can be placed within the drum and a closed position wherein the washing machine is substantially sealed;
a sump comprising a multiplicity of solid particles and wash liquor;
pumping means configured to pump said multiplicity of solid particles into the drum via one or more ducts;
a supply of a treatment gas comprising ozone; and
one or more conduits to convey said treatment gas to a bubble generator wherein said bubble generator is operable to form bubbles of said treatment gas in said wash liquor.

40. A washing machine according to claim 39 wherein said bubbles have an average diameter of no more than 10 mm, preferably no more than 1 mm.

41. A washing machine according to claim 39 further comprising
a gas source to provide a feed gas comprising oxygen;
a plasma generator comprising electrodes, having a space between them which is preferably no more than 10 mm, preferably no more than 1 mm, and preferably at least 0.001 mm;
one or more delivery conduit(s) to transport said feed gas from the gas source through the space between the electrodes; and
a power source to apply a voltage across the electrodes to dissociate the oxygen to form a treatment gas comprising ozone.

42. (canceled)

43. A method of treating one or more substrates, the method comprising agitating said one or more substrates in a treatment formulation comprising a multiplicity of solid particles, a liquid medium and bubbles of ozone.

44. A method according to claim 43 wherein said bubbles of ozone have an average diameter of no more than 10 mm, preferably no more than 1 mm.

45. A method according to claim 43 further comprising pre-treatment of said multiplicity of solid particles with bubbles of ozone prior to contact of said particles with said substrate(s), preferably wherein said bubbles of ozone have an average diameter of no more than 10 mm, preferably no more than 1 mm.

46. A method according to claim 43 wherein said method comprises a step (A) of pre-treatment of said multiplicity of solid particles with bubbles of ozone prior to contact of said particles with said substrate(s), preferably wherein said bubbles of ozone have an average diameter of no more than 10 mm, preferably no more than 1 mm, and further comprises a step (B) of agitating said substrate(s) with a treatment formulation comprising said pre-treated multiplicity of solid particles, a liquid medium and bubbles of ozone, preferably wherein said bubbles of ozone have an average diameter of no more than 10 mm, preferably no more than 1 mm, wherein said ozone bubbles in step (B) are generated additionally to the ozone bubbles in step (A).

47. A method according to claim 43 wherein the method comprises cleaning said one or more substrates.

48. A method according to claim 43 wherein the method comprises bleaching and/or oxidising the one or more substrates.

49. A method according to claim 43 wherein the method comprises applying a shrink resist treatment to said one or more substrates and wherein said one or more substrates are keratinous substrates such as wool or woollen garments.

50. A method according to claim 43 wherein the one or more substrates comprises a textile material, in particular one or more garments, linens, napery, towels or the like.

51. A method according to claim 43 wherein the method of treating said one or more substrates can be a paper or cardboard recycling process or a de-inking process.

52. A method according to claim 43 wherein the treatment formulation comprises water.

53. A method as claimed in claim 43 wherein the treatment formulation comprises at least one surfactant and/or at least one detergent composition.

54. A method as claimed in claim 43 wherein the treatment formulation comprises at least one enzyme.

55. A method as claimed in claim 43 using the apparatus of any of claims 1 to 38, particularly wherein the method comprises cleaning said one or more substrates and wherein the method comprises using a washing machine comprising: a housing containing a drum rotatably mounted therein wherein said drum is configured to receive wash liquor;
access means moveable between an open position wherein said one or more substrates can be placed within the drum and a closed position wherein the washing machine is substantially sealed;
a sump comprising a multiplicity of solid particles and wash liquor;
pumping means configured to pump said multiplicity of solid particles into the drum via one or more ducts;
a supply of a treatment gas comprising ozone; and
one or more conduits to convey said treatment gas to a bubble generator wherein said bubble generator is operable to form bubbles of said treatment gas in said wash liquor.

56. The method according to claim 43 wherein the multiplicity of solid particles does not penetrate the surface of the one or more substrates.

57. A method of preparing a multiplicity of solid particles for use in the treatment of one or more substrates, the method comprising a first step of: agitating said multiplicity of solid particles with bubbles of ozone in a liquid medium, preferably wherein said bubbles have an average diameter of no more than 10 mm, preferably no more than 1 mm.

58. A method as claimed in claim 57 wherein said first step is conducted immediately prior to agitating said multiplicity of solid particles with said one or more substrates.

59. A method of inhibiting the growth or accumulation of bacteria in one or more internal components of a washing machine, the method comprising circulating a formulation comprising a liquid medium and bubbles of ozone within the interior of said washing machine, wherein the formulation further comprises a multiplicity of solid particles, preferably wherein said bubbles have an average diameter of no more than 10 mm, preferably no more than 1 mm.

60. An apparatus of claim 1 wherein said bubbles have an average diameter of from 1 micron to 1 mm.

61. A washing machine of claim 39, wherein said bubbles have an average diameter of from 1 micron to 1 mm.

62. A method of claim 43, wherein said bubbles have an average diameter of from 1 micron to 1 mm.

63. A method of claim 57, wherein said bubbles have an average diameter of from 1 micron to 1 mm.
